(19) United States
(12) Patent Application Publication
(10) Pub. No.: US 2009/0244173 A1
(43) Pub. Date: Oct. 1, 2009

(54) Nozzle plate, liquid ejection head and image forming apparatus

(75) Inventor: Tsutomu Yokouchi, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/385,051

(22) Filed: Mar. 30, 2009

(30) Foreign Application Priority Data
Mar. 31, 2008 (JP) 2008-093092

(51) Int. Cl. B41J 2/165; B41J 2/16

(52) U.S. Cl. 347/33; 347/47

(57) ABSTRACT

The nozzle plate has: a plurality of nozzles which eject a liquid; and a plurality of projecting sections formed in a broken line shape or an island shape about periphery of the plurality of nozzles on a liquid ejection surface of the nozzle plate.

### BACKGROUND OF THE INVENTION

1. Field of the Invention

The present invention relates to a nozzle plate in which nozzles that eject liquid are formed, a liquid ejection head and an image forming apparatus.

2. Description of the Related Art

It is possible to form images of high resolution and high quality with low running costs, by ejecting inks toward a recording medium from a plurality of nozzles formed on a nozzle plate. The ink ejection head comprising a nozzle plate may be based on, for example, a piezoelectric method which uses the displacement of a piezoelectric element, or a thermal method which uses thermal energy generated by a heating element, or the like.

Japanese Patent Application Publication No. 09-099558 discloses a structure in which wave-shaped walls (crater sections) are formed following the direction of arrangement of the nozzles. Paper dust and ink residue which are swept away are caused to collect in the narrow recess sections created by the projecting sections of the walls of the crater sections.

In the structure disclosed in Japanese Patent Application Publication No. 09-099558, dirt collects in the recess sections of the wave-shaped walls, but for structural reasons, dirt remains in the periphery of the nozzles and therefore the dirt is not removed completely.

### SUMMARY OF THE INVENTION

The present invention has been contrived in view of the aforementioned circumstances, an object thereof being to provide a nozzle plate which has good properties in terms of the removal of surplus ink and dirt during wiping, and to provide a liquid ejection head and an image forming apparatus in relation to that.

In order to attain an object described above, one aspect of the present invention is directed to a nozzle plate comprising: a plurality of nozzles which eject a liquid; and a plurality of projecting sections formed in a broken line shape or an island shape about periphery of the plurality of nozzles on a liquid ejection surface of the nozzle plate.

In this aspect of the invention, “broken line shape” means a shape in which a straight line or curved line is broken into a plurality of portions. The respective portions thus divided are projecting sections. The method of forming projecting sections in a “broken line shape” may involve forming the projecting sections with a broken shape in advance, or forming same by actually breaking a line shape. Furthermore, in the present specification, “island shape” means a shape whereby the projecting sections are mutually and respectively isolated from each other, rather than having a “broken line shape”. These respective isolated portions are projecting sections. The specific shape of the “island-shaped” projecting sections is not limited in particular to a circular or elliptical shape. Projecting sections of a “broken line shape” or “island shape” also include shapes having a lengthwise direction and a breadthways direction (for example, a line segment shape).

According to this aspect of the invention, since a plurality of projecting sections are formed in a broken line shape or an island shape about the periphery of the nozzles on the liquid ejection surface (also called “ejection surface”), then as well as protecting the nozzles during wiping, it is also possible to move the surplus ink and dirt on the ejection surface in such a manner that none remains about the periphery of the nozzle.

Desirably, the plurality of projecting sections are formed in an inclined shape with respect to a wiping direction of the nozzle plate.

According to this aspect of the invention, it is possible to move the surplus ink and dirt smoothly away from the nozzles during wiping, in addition to which it is also possible to reduce the damage caused to the wiping member and the projecting sections themselves in comparison with a case where projecting sections are formed in a perpendicular shape with respect to the wiping direction.

Desirably, the plurality of projecting sections are formed in a parallel shape with respect to a wiping direction of the nozzle plate.

According to this aspect of the invention, it is possible to move the surplus ink and dirt smoothly in the wiping direction during the wiping action, and furthermore it is also possible to reduce the damage caused to the wiping member and the projecting sections themselves.

Desirably, the plurality of projecting sections are formed in a lattice configuration constituted by first lines which are inclined with respect to the wiping direction and second lines which are parallel to the wiping direction, with the projecting sections at intersecting portions between the first lines and the second lines being removed from the lattice configuration.

If the projecting sections are formed in a lattice configuration on the ejection surface, then the intersecting portions between the lines are liable to become high when the projecting sections are formed, and damage is liable to be caused to the wiping member and the projecting sections themselves during a wiping action. However, according to this aspect of the invention, since the intersecting portions are omitted, then it is possible to reduce the damage caused to the wiping member and the projecting sections themselves during wiping.

In order to attain an object described above, another aspect of the present invention is directed to, a nozzle plate comprising: a plurality of nozzles which eject a liquid; and a plurality of projecting sections which have an inclined shape with respect to a wiping direction of the nozzle plate and are formed about periphery of the plurality of nozzles on a liquid ejection surface of the nozzle plate.

According to this aspect of the invention, projecting sections having an inclined shape are formed about the periphery of the nozzles on the ejection surface, and therefore the nozzles are protected during wiping, as well as being able to move the surplus ink and dirt on the ejection surface, smoothly in a direction away from the nozzles. Furthermore, it is possible to reduce the damage caused to the wiping member and the projecting sections themselves in comparison with a case where projecting sections are formed in a perpendicular shape with respect to the wiping direction.

Desirably, the plurality of projecting sections are disposed between the nozzles in the wiping direction.

According to this aspect of the invention, it is possible reliably to control the infiltration of dirt into the nozzles during a wiping action.

Desirably, the plurality of projecting sections include: first projecting sections having an inclined shape toward one side with respect to the wiping direction; and second projecting sections having an inclined shape toward another side respect to the wiping direction.

According to this aspect of the invention, it is possible to move the surplus ink and dirt on the ejection surface in a distributed fashion to either side, during a wiping action.

Desirably, the first projecting sections and the second projecting sections are formed alternately between the nozzles in the wiping direction.

According to this aspect of the invention, it is possible readily to control the infiltration of dirt into the nozzles during a wiping action, as well as being able to move the surplus ink and dirt on the ejection surface in a distributed fashion to either side.

Desirably, the plurality of nozzles are arranged in form of a plurality of nozzle rows in the wiping direction; of the nozzle rows arranged adjacently, the first projecting sections are arranged in one nozzle row and the second projecting sections are arranged in another nozzle row; and the first projecting sections and the second projecting sections are disposed between the nozzles in the respective nozzle rows.

According to this aspect of the invention, it is possible to move the surplus ink and dirt on the ejection surface smoothly to the outside of the nozzle row.

Desirably, the plurality of nozzles are arranged in the wiping direction to form a nozzle row; and the plurality of projecting sections are disposed in a distributed fashion between the nozzles in the nozzle row, and in a portion outside of the nozzle row.

According to this aspect of the invention, it is possible to move the surplus ink and dirt on the ejection surface further away from the nozzles, during a wiping action.

Desirably, the plurality of projecting sections are formed in a lattice configuration constituted by first lines which are inclined with respect to the wiping direction and the second lines which are parallel to the wiping direction.

Desirably, the plurality of projecting sections are formed in an undulating line shape which bends back and forth repeatedly while passing between the plurality of nozzles.

Desirably, the plurality of projecting sections are formed of a curable resin material.

Desirably, the plurality of projecting sections have surfaces with a curved shape.

In order to attain an object described above, another aspect of the present invention is directed to a liquid ejection head comprising any one of the above-described nozzle plates.

In order to attain an object described above, another aspect of the present invention is directed to an image forming apparatus comprising the liquid ejection head.

According to the present invention, good properties are obtained in terms of the removal of surplus ink and dirt during a wiping action.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1A is a plan diagram illustrating one example of a nozzle plate according to a first embodiment and FIG. 1B is a cross-sectional diagram along line 1B-1B in FIG. 1A;

FIG. 2 is a plan diagram illustrating one example of a nozzle plate according to a second embodiment;

FIG. 3 is a plan diagram illustrating one example of a nozzle plate according to a third embodiment;

FIG. 4 is a plan diagram illustrating a first example of a nozzle plate according to a fourth embodiment;

FIG. 5 is a plan diagram illustrating a second example of a nozzle plate according to the fourth embodiment;

FIG. 6 is a plan diagram illustrating a third example of a nozzle plate according to the fourth embodiment;

FIG. 7 is a plan diagram illustrating a fourth example of a nozzle plate according to the fourth embodiment;

FIG. 8 is a plan diagram illustrating a fifth example of a nozzle plate according to the fourth embodiment;

FIG. 9 is a plan diagram illustrating a sixth example of a nozzle plate according to the fourth embodiment;

FIG. 10 is a plan diagram illustrating a seventh example of a nozzle plate according to the fourth embodiment;

FIG. 11 is a plan diagram illustrating an eighth example of a nozzle plate according to the fourth embodiment;

FIG. 12 is a plan diagram illustrating a ninth example of a nozzle plate according to the fourth embodiment;

FIG. 13 is a plan diagram illustrating one example of a nozzle plate according to a fifth embodiment;

FIG. 14 is a plan diagram illustrating one example of a nozzle plate according to a sixth embodiment;

FIG. 15 is a plan diagram illustrating a further example of a nozzle plate according to the sixth embodiment;

FIG. 16 is a plan diagram illustrating one example of a nozzle plate according to a seventh embodiment;

FIG. 17 is a plan diagram illustrating one example of a nozzle plate according to an eighth embodiment;

FIGS. 18A to 18D are step diagrams for describing a method of manufacturing a nozzle plate;

FIGS. 19A to 19C are plan diagrams of FIGS. 18A to 18D;

FIG. 20 is an illustrative diagram illustrating an example in which a liquid-repelling film is also formed on top of the resin;

FIGS. 21A to 21C are step diagrams illustrating an example where patterning is carried out during the formation of a liquid-repelling film;

FIG. 22 is a general schematic drawing of an inkjet recording apparatus relating to an embodiment of the present invention;

FIGS. 23A and 23B are plan view perspective diagrams illustrating an example of the composition of a print head;

FIG. 24 is a plan view perspective diagram illustrating a further example of the structure of a full line head;

FIG. 25 is a cross-sectional diagram along line 25-25 in FIGS. 23A and 23B;

FIG. 26 is an enlarged view illustrating a nozzle arrangement in the print head illustrated in FIGS. 23A and 23B;

FIG. 27 is a schematic drawing of an ink supply system;

FIG. 28 is a principal block diagram illustrating the system configuration of the inkjet recording apparatus;

FIG. 29 is a principal schematic drawing illustrating an example of the composition of an inkjet recording apparatus of an intermediate transfer type; and

FIG. 30 is a principal schematic drawing illustrating a further example of the composition of an inkjet recording apparatus of an intermediate transfer type.

### DETAILED DESCRIPTION OF THE PREFERRED EMBODIMENTS

### First Embodiment

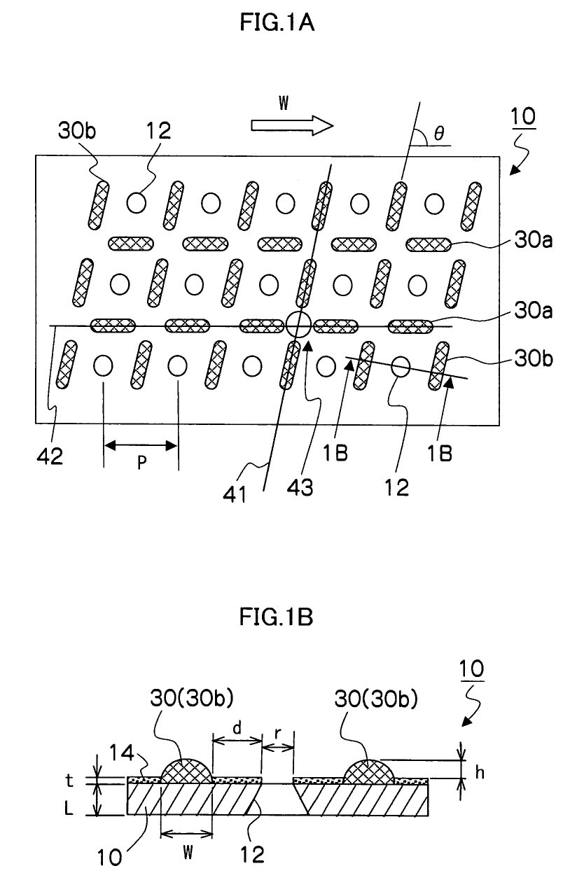

FIG. 1A is a plan diagram illustrating one example of a nozzle plate according to a first embodiment. FIG. 1B is a cross-sectional diagram along line 1B-1B in FIG. 1A. For the nozzle plate 10, nozzles 12 (ejection ports), which eject liquid, are formed so as to pass through the nozzle plate 10. The upper side in FIG. 1B is the liquid ejection side, and the liquid passing through the nozzle 12 is ejected from the lower to the upper side in FIG. 1B.

A plurality of projecting sections 30 (30a, 30b) are formed in a projecting fashion in a broken line shape, on the liquid ejection surface (ejection surface) of the nozzle plate 10.

In the present example, the projecting sections 30 are formed in a lattice configuration constituted by lines 41 which are inclined with respect to the wiping direction W of the nozzle plate 10 and lines 42 which are parallel to the wiping direction W, the intersection portions 43 between the lines 41 and 42 being removed from the lattice configuration. Since the projecting sections 30 are formed in such a manner that they do not intersect with each other on the ejection surface, then when the ejection surface is wiped by a wiping member (for example, a blade) (not illustrated), the surplus ink moved over the ejection surface by the wiping action does not remain in the vicinity of the nozzles 12, but rather is moved toward the exterior of the ejection surface by passing through the gaps 43 (break sections) between the respective projecting sections 30. In other words, the properties of removing surplus ink and dirt are improved. By this means, paper dust created by the recording medium and aggregate material generated from the ink, and the like, can be removed swiftly from the vicinity of the nozzles 12, together with the surplus ink, during a wiping action.

In the present example, projecting sections 30a having a parallel form with respect to the wiping direction W (angle of inclination θ=0°) (hereinafter, called “parallel projecting sections”) and projecting sections 30b having an inclined form with respect to the wiping direction at an acute angle of inclination (0°<angle of inclination θ<90°) (hereinafter, called “oblique projecting sections”) are provided in a projecting fashion on the ejection surface of the nozzle plate 10. The appropriate angle of inclination θ varies with the material of the wiping member and the wiping conditions, and the like, but it is between 0° and approximately 75°. If there are projecting sections having a perpendicular shape with respect to the wiping direction W (an angle of inclination θ=90°), then ink removal properties become worse and significant damage is caused to the wiping member and the projecting sections themselves. In the present example, by forming parallel projecting sections 30a and oblique projecting sections 30b, the damage to the wiping member and the actual projecting sections 30 during wiping is reduced. Since the ink is moved in the wiping direction W by means of the parallel projection sections 30a during wiping, and furthermore the ink is moved in a direction away from the periphery of the nozzles 12 (obliquely in the upward and rightward direction in FIG. 1A) by means of the oblique projecting sections 30b, then the surplus ink and dirt are wiped smoothly away from the ejection surface.

Moreover, the projecting sections 30 (30a and 30b) are formed in a projecting fashion so as to surround the nozzles 12 on the ejection surface, and therefore the fluidity of the ink in the vicinity of the nozzles 12 during wiping is ensured, as well as preventing the infiltration of foreign material into the nozzles 12.

Furthermore, the projecting sections 30 (30a, 30b) are made of a curable resin, such as heat-curable resin or ultraviolet-curable ink, and are formed so as to have curved upper surfaces due to the surface tension of the resin before curing. In the example illustrated in FIG. 1B, the cross-section of a projecting section 30 in the breadthways direction is approximately a semi-circular shape. In actual practice, the exact shape depends on the volume of resin in liquid form before curing and the magnitude of the surface tension, as well as other factors, but the surface has a curved shape. Since the projecting sections 30 have a curved upper surface, then very little damage is caused to the wiping member and the projecting sections 30 themselves during wiping.

A liquid-repelling film 14 having liquid-repelling properties is deposited onto the ejection surface of the nozzle plate 10 according to the present embodiment. The projecting sections 30 are portions which are rendered liquid-repelling (liquid-repelling portions) by removing (or modifying) portions of the liquid-repelling film 14 on the ejection surface. The method of forming projecting sections 30 of this kind is described in detail below.

As an example of the specific dimensions of the nozzle plate used in the inkjet recording apparatus, the diameter r of the nozzles 12 is 10 to 50 μm, the length L of the nozzles 12 is 10 to 100 μm, the thickness t of the liquid-repelling film 14 is several nm to 5 μm, and the pitch P of the nozzles 12 is 40 to 1000 μm. For example, the distance d from the edge of the nozzle 12 to the projecting section 30 is set in the range of 10 to 100 μm, the height h of the projecting section 30 is set in the range of 10 to 50 μm, and the width W of the projecting section 30 is set in the range of 10 to 300 μm, as appropriate.

### Second Embodiment

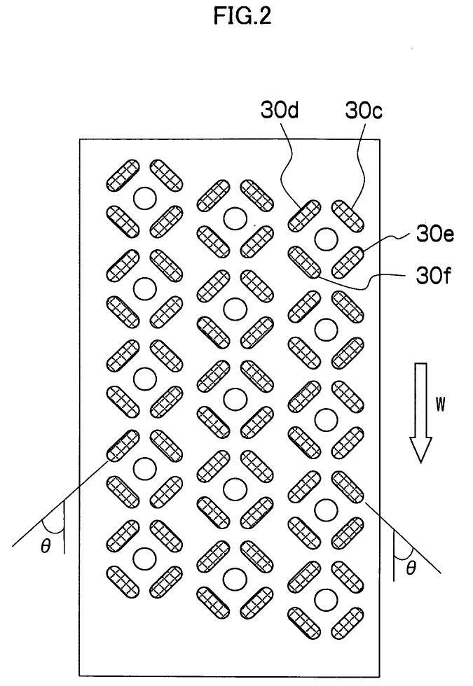

FIG. 2 is a plan diagram illustrating one example of a nozzle plate according to a second embodiment. In FIG. 2, the same reference numerals are assigned to portions which are the same as those illustrated in FIGS. 1A and 1B. The cross-sectional shape of the oblique projecting sections 30e and 30f is similar to the projecting sections 30a and 30b in the first embodiment. Here, only the parts which are different to the nozzle plate of the first embodiment will be described.

Island-shaped oblique projecting sections 30c, 30d, 30e, 30f are provided in a projecting fashion on the ejection surface of the nozzle plate illustrated in FIG. 2, in a symmetrical arrangement about the nozzle 12 in respect of the wiping direction W. The oblique projecting sections indicated by reference numeral 30c have an inclined shape toward one side (the rightward direction in FIG. 2) with respect to the wiping direction W. Furthermore, the oblique projecting sections indicated by reference numeral 30d have an inclined shape toward the other side (the leftward direction in FIG. 2) with respect to the wiping direction W. If the wiping member is slid only in one direction (from the upper side to the lower side in FIG. 2), then the oblique projecting sections indicated by reference numerals 30e and 30f can be omitted. In the present example, the angle of inclination θ of the oblique projecting sections 30c to 30f is approximately 45°.

### Third Embodiment

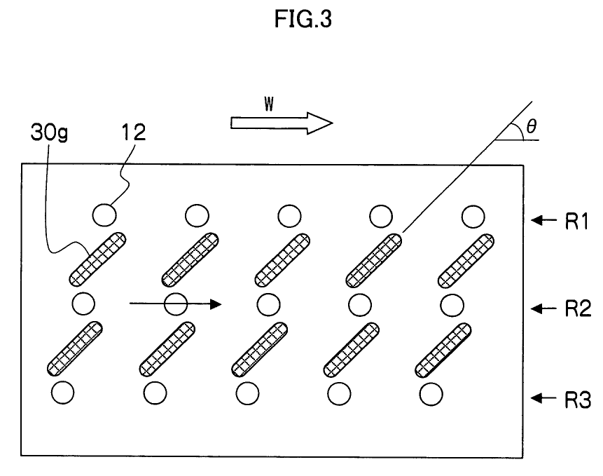

FIG. 3 is a plan diagram illustrating one example of a nozzle plate according to a third embodiment. In FIG. 3, the same reference numerals are assigned to portions which are the same as those illustrated in FIGS. 1A and 1B. The cross-sectional shape of the oblique projecting sections 30g is similar to the projecting sections 30a and 30b in the first embodiment. Here, only the part which is different to the nozzle plate 10 illustrated in FIGS. 1A and 1B will be described.

In FIG. 3, island-shaped oblique projecting sections 30g are arranged between the rows of nozzles 12 which are arranged following the wiping direction W (namely, between rows R1 and R2 and between rows R2 and R3). The angle of inclination θ in the present example is approximately 45°.

### Fourth Embodiment

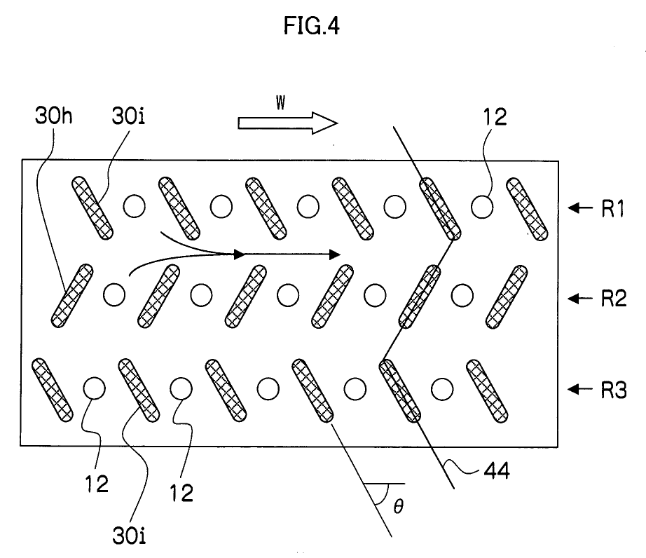

FIG. 4 is a plan diagram illustrating one example of a nozzle plate according to a fourth embodiment. In FIG. 4, the same reference numerals are assigned to portions which are the same as those illustrated in FIGS. 1A and 1B. The cross-sectional shape of the oblique projecting sections 30h and 30i is similar to the projecting sections 30a and 30b in the first embodiment. Here, only the part which is different to the nozzle plate 10 illustrated in FIGS. 1A and 1B will be described.

In FIG. 4, island-shaped oblique projecting sections (first oblique projecting sections 30h and second oblique projecting sections 30i) are arranged between the respective nozzles 12 which are arranged following the wiping direction W. In the present example, it is also possible to form broken line-shaped oblique projecting sections 30h, 30i in the form of an undulating line 44 which is broken on the upstream side of the nozzles 12 in terms of the wiping direction W. The angle of inclination θ in the present example is approximately 45°.

The first oblique projecting sections 30h are inclined to one side with respect to the wiping direction W (the upper side in FIG. 4), and the second oblique projecting sections 30i are inclined to the other side with respect to the wiping direction W (the lower side in FIG. 4). In the present embodiment, since the inclined projecting sections 30h, 30i are formed between the nozzles 12, then the dirt to the upstream side of the nozzles 12 does not enter into the nozzles 12, but rather is moved between the nozzle rows (between rows R1 and R2, and rows R2 and R3), together with the surplus ink.

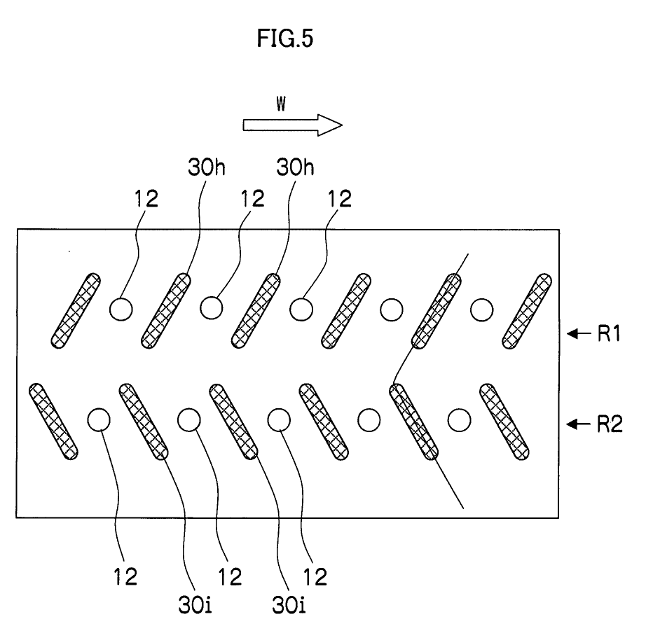

FIGS. 5 to 8 illustrate cases where there are two rows of nozzles.

In FIG. 5, of the mutually adjacent nozzle rows R1 and R2, the first oblique projecting sections 30h are formed in the first nozzle row R1 and the second oblique projecting sections 30i are formed in the second nozzle row R2. Furthermore, the oblique projecting sections 30h and 30i are arranged between the respective nozzles 12, in the nozzle row R1 and the nozzle row R2, respectively. By this means, it is possible to direct the dirt in an oblique direction with respect to the wiping direction W (toward the upper side and lower side in the drawings: namely, outwards from the nozzle rows R1 and R2).

If the second oblique projecting sections 30i are formed in the first nozzle row R1 and the first oblique projecting sections 30h are formed in the second nozzle row R2, then it is possible to direct dirt to a portion (central position) between the nozzle rows following the wiping direction W.

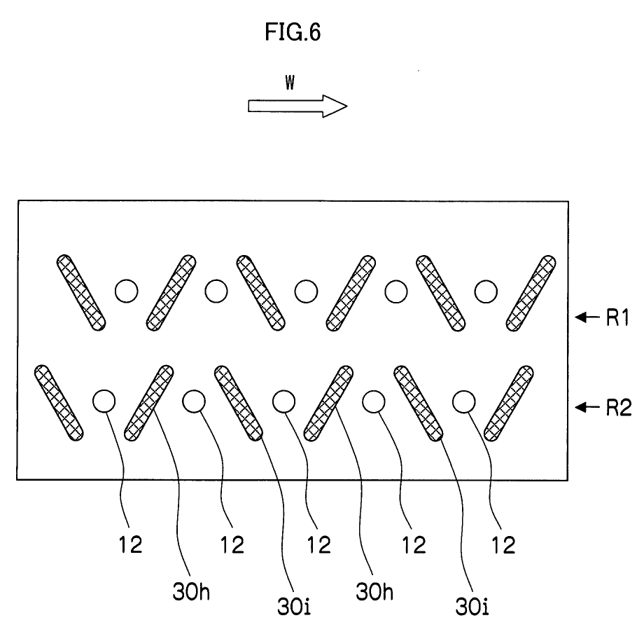

In FIG. 6, in the respective nozzle rows R1 and R2, a first oblique projecting section 30h and a second oblique projecting section 30i are formed alternatively in each interval between nozzles 12. By this means, dirt can be directed in an oblique direction with respect to the wiping direction W (towards the upper side and lower side in FIG. 6: namely, outwards from the rows R1 and R2), and in a direction following the wiping direction W (the center of the diagram: between rows R1 and R2).

In summary, the structure in FIG. 5 expels dirt out to the sides from the region in which the nozzles 12 are arranged, and the structure in FIG. 6 expels dirt out in an evenly distributed fashion.

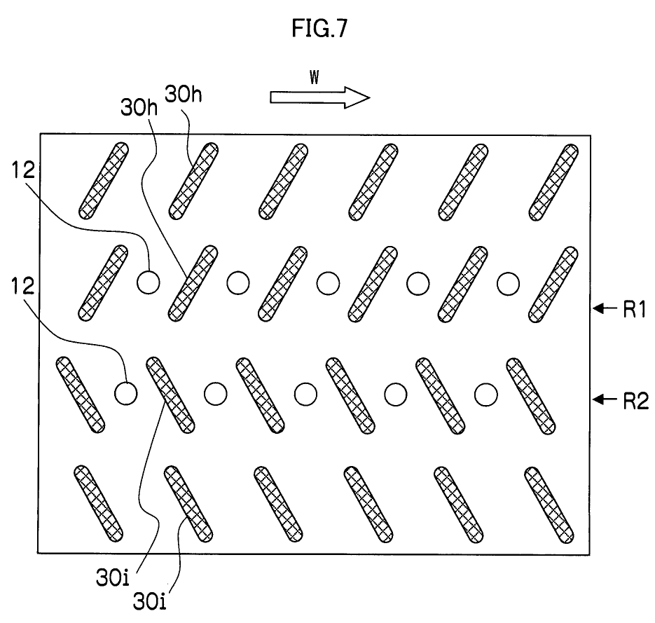

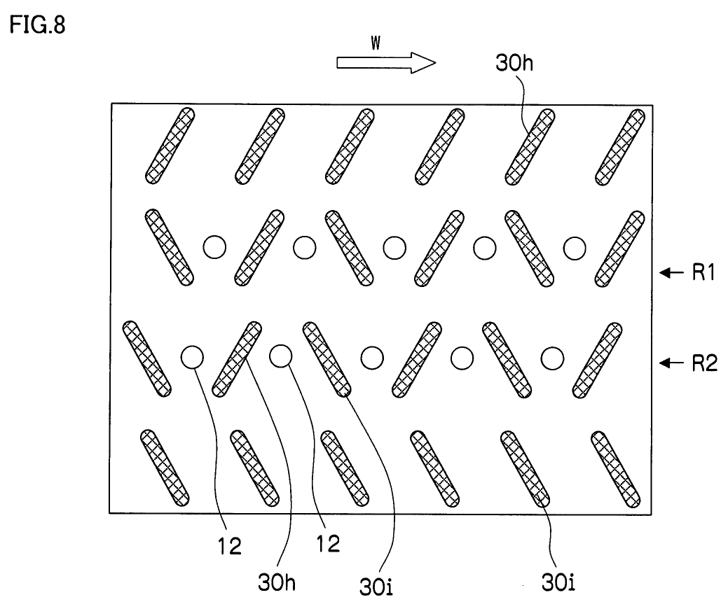

The structure illustrated in FIG. 7 is a structure in which oblique projecting sections 30h and 30i are appended to the structure illustrated in FIG. 5, to the outer sides of the nozzle rows R1 and R2. First oblique projecting sections 30h are formed yet further to the outer side of the first nozzle row R1 (the upper side in FIG. 7), and second oblique projecting sections 30i are formed yet further to the outer side of the second nozzle row R2. Furthermore, in FIG. 8, oblique projecting sections 30h and 30i are appended to the structure illustrated in FIG. 6, to the outer sides of the nozzle rows R1 and R2. In these structures, it is possible to expel the dirt further out from the nozzles 12.

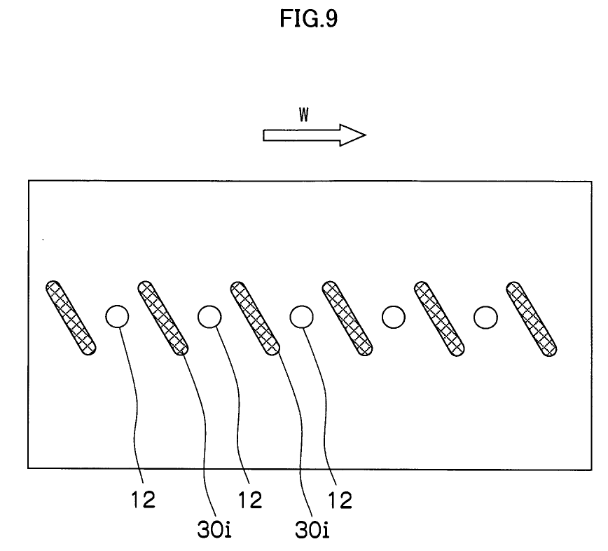

FIGS. 9 to 12 illustrate cases where there is one row of nozzles.

In the structure illustrated in FIG. 9, oblique projecting sections 30i of the same shape are formed in the gaps between nozzles 12. By this means, it is possible to direct dirt out in one oblique direction (toward the lower side in FIG. 9) with respect to the wiping direction W.

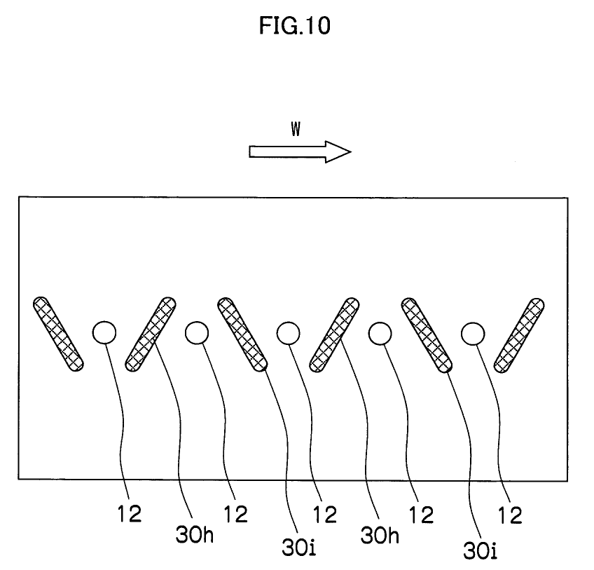

In the structure illustrated in FIG. 10, first oblique projecting sections 30h and second oblique projecting sections 30i are formed alternately in the gaps between the nozzles 12. By this means, it is possible to direct dirt out in both oblique directions (toward the upper side and lower side in FIG. 10) with respect to the wiping direction W.

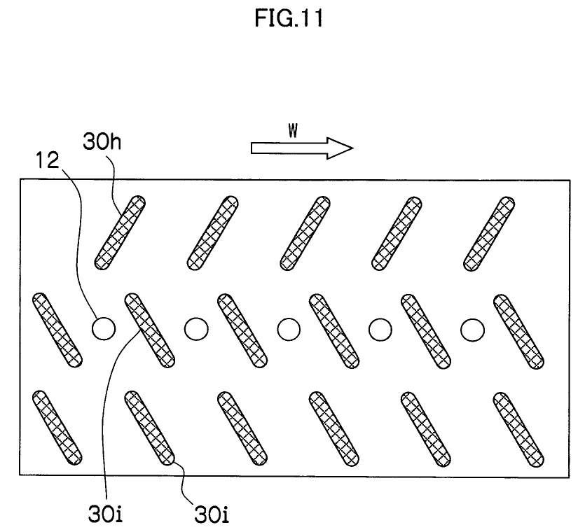

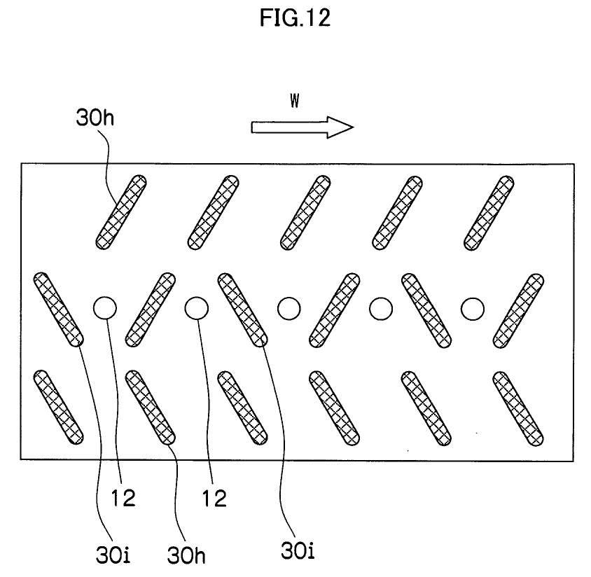

The structure illustrated in FIG. 11 is a structure in which oblique projecting sections 30h and 30i are appended to the structure illustrated in FIG. 9, to the outer sides of the nozzle row. The structure illustrated in FIG. 12 is a structure in which oblique projecting sections 30h are appended to the structure illustrated in FIG. 10, to the outer sides of the nozzle row. In these structures, it is possible to expel the dirt further out from the nozzles 12.

### Fifth Embodiment

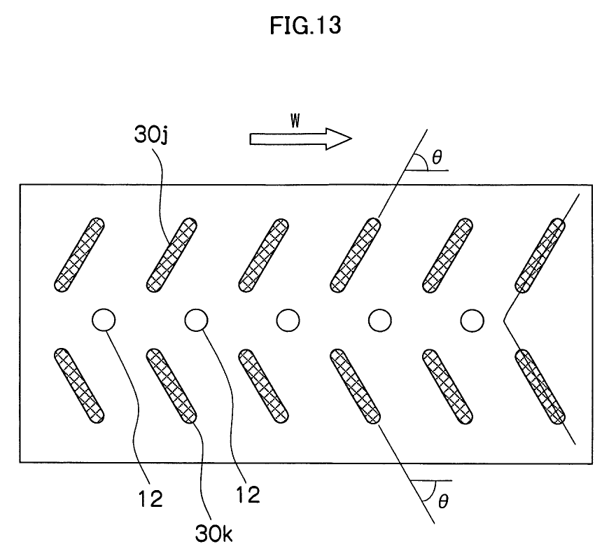

FIG. 13 is a plan diagram illustrating one example of a nozzle plate according to a fifth embodiment. In FIG. 13, the same reference numerals are assigned to portions which are the same as those illustrated in FIGS. 1A and 1B. The cross-sectional shape of the oblique projecting sections 30j and 30k is similar to the oblique projecting sections 30a and 30b in the first embodiment. Here, only the part which is different to the nozzle plate 10 illustrated in FIGS. 1A and 1B will be described.

If there is a narrow gap between the nozzles 12 and it is difficult to form projecting sections between the nozzles 12, then as illustrated in FIG. 13, first oblique projecting sections 30j are formed on one side of the nozzle row (the upper side in FIG. 13) and second oblique projecting sections 30k are formed on the other side of the nozzle row (the lower side in FIG. 13). The oblique projecting sections 30j, 30k have a shape which is inclined obliquely toward the downstream side in terms of the wiping direction W. Accordingly, it is possible to direct the dirt efficiently from the vicinity of the nozzles 12 toward the outside. The angle of inclination θ in the present example is approximately 45°.

### Sixth Embodiment

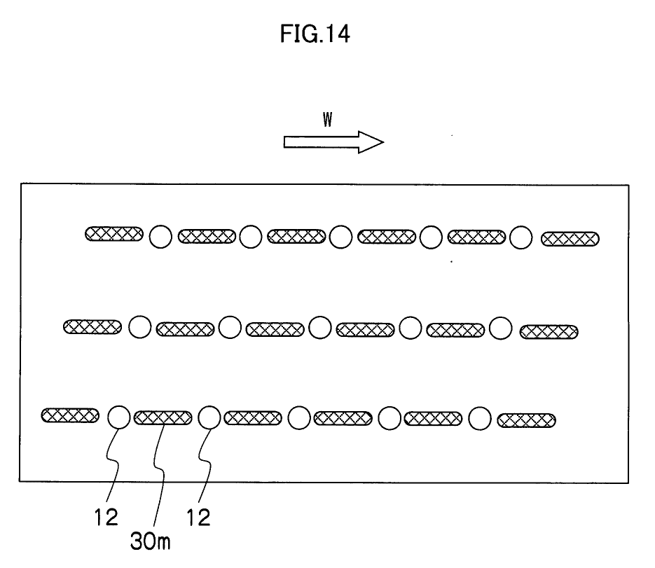

FIG. 14 is a plan diagram illustrating one example of a nozzle plate according to a sixth embodiment. In FIG. 14, the same reference numerals are assigned to portions which are the same as those illustrated in FIGS. 1A and 1B. The cross-sectional shape of the projecting sections 30m is similar to the projecting sections 30a and 30b in the first embodiment. Here, only the part which is different to the nozzle plate 10 illustrated in FIGS. 1A and 1B will be described.

FIG. 14 illustrates a case where parallel projecting sections 30m having a straight line segment shape are formed between the nozzles 12. The parallel projecting sections 30m have a shape that is parallel to the wiping direction W.

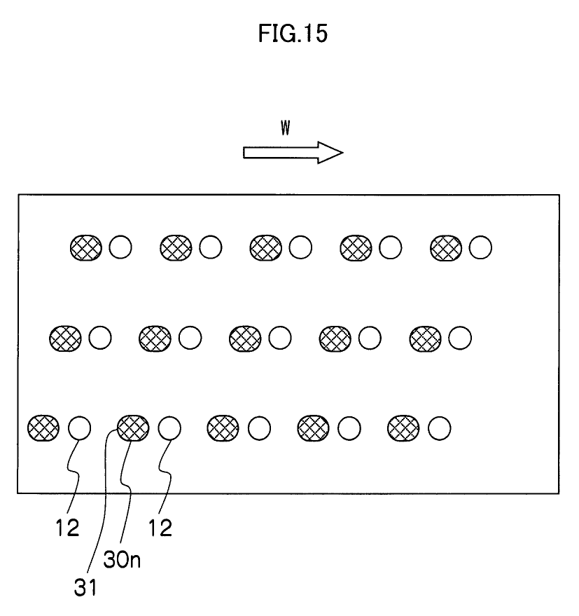

FIG. 15 illustrates a case where projecting sections 30n having an approximately circular shape are formed between the nozzles 12. The shape is not limited in particular to a circular shape. Desirably, the portion 31 on the upstream side in the wiping direction W is a shape having a curve with respect to the wiping direction W.

### Seventh Embodiment

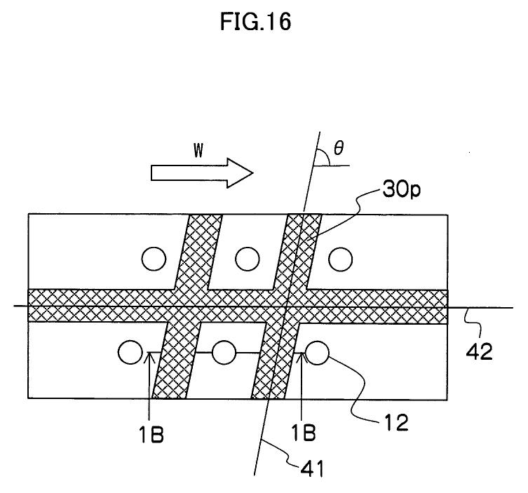

FIG. 16 is a plan diagram illustrating one example of a nozzle plate according to a seventh embodiment. In FIG. 16, the same reference numerals are assigned to portions which are the same as those illustrated in FIGS. 1A and 1B. The cross-sectional shape of the projecting sections 30p is similar to the projecting sections 30a and 30b in the first embodiment. Here, only the part which is different to the nozzle plate 10 illustrated in FIGS. 1A and 1B will be described.

In the present embodiment, projecting sections 30p are formed in a lattice configuration comprising lines 41 which are inclined with respect to the wiping direction and lines 42 which are parallel to the wiping direction P.

### Eighth Embodiment

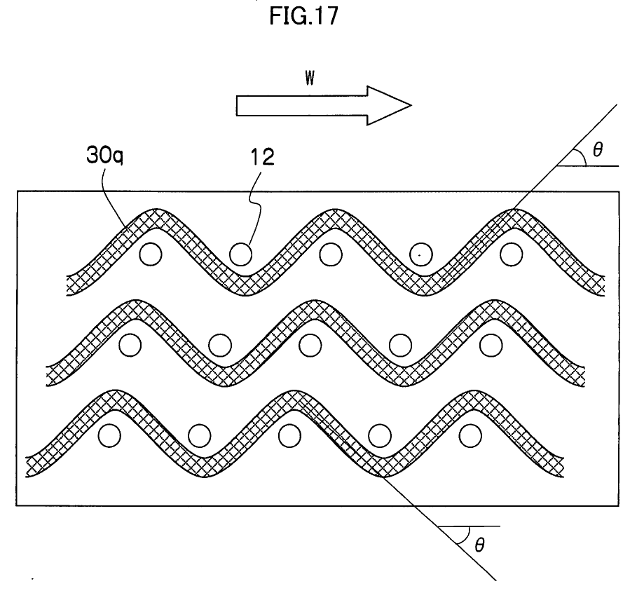

FIG. 17 is a plan diagram illustrating one example of a nozzle plate according to an eighth embodiment. In FIG. 17, the same reference numerals are assigned to portions which are the same as those illustrated in FIGS. 1A and 1B. The cross-sectional shape of the projecting sections 30q is similar to the projecting sections 30a and 30b in the first embodiment. Here, only the part which is different to the nozzle plate 10 illustrated in FIGS. 1A and 1B will be described.

In the present embodiment, projecting sections 30q are formed in the shape of continuous curved lines (undulating lines) which bend back and forth so as weave between the nozzles 12 that are arranged in the winding direction W. The undulating line-shaped projecting sections 30q created by this resin are formed at a suitable oblique angle with respect to the wiping direction W which minimizes the damage caused by the blade. The present example illustrates a mode in which an oblique line segment having an angle of inclination of approximately 45° bends back and forth in a repeating fashion, each of the respective bend portions being formed in a circular arc shape. The angle of inclination θ is an acute angle (0°<θ<90°) and desirably is equal to or less than 60°.

### Method for Manufacturing Nozzle Plate

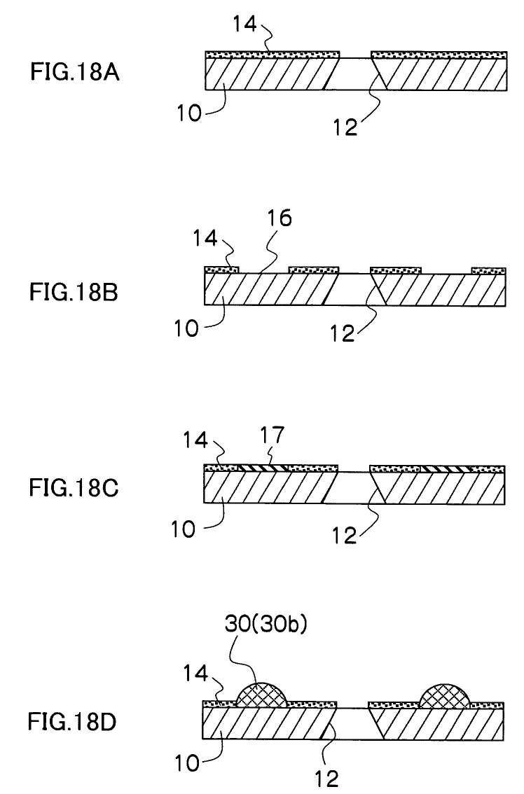

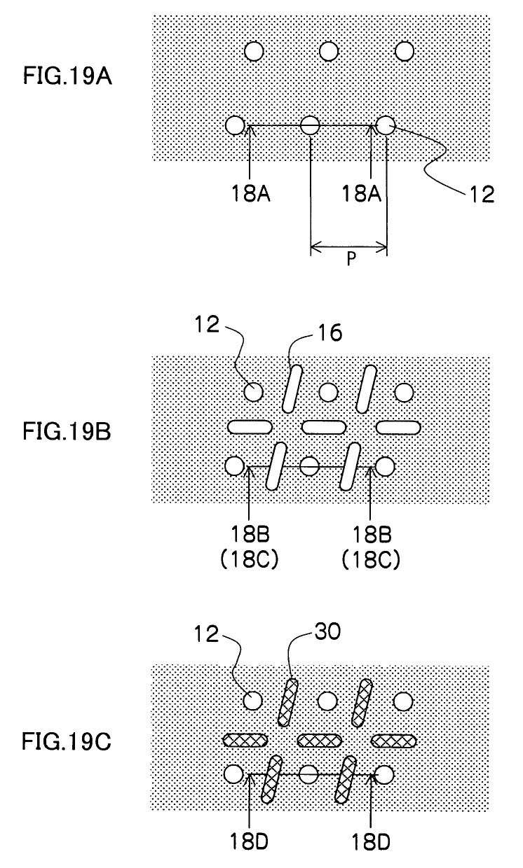

FIGS. 18A to 19C are explanation diagrams illustrating one example of the method of manufacturing nozzle plate. FIGS. 18A to 18D are cross-sectional diagrams and FIGS. 19A to 19C are plan diagrams illustrating a nozzle plate viewed from the ejection direction. FIG. 18A illustrates a cross-sectional view along line 18A-18A in FIG. 19A, FIGS. 18B and 18C illustrate cross-sectional views along line 18B-18B (18C-18C) in FIG. 19B, and FIG. 18D illustrates a cross-sectional view along line 18D-18D in FIG. 19C. In the present example, the nozzle plate 10 illustrated in FIGS. 1A and 1B is manufactured.

### Step 1: Step of Forming Nozzles and Liquid-Repelling Film

Firstly, as illustrated in FIG. 18A, a liquid-repelling film 14 is formed on the liquid ejection side surface of a nozzle plate 10 which comprises nozzles 12. Various methods can be chosen as the concrete method of obtaining the nozzle plate 10 having the nozzles 12 and the liquid-repelling film 14. For example, the nozzles are formed by etching a silicon substrate, whereupon the liquid-repelling film 14 is formed by coating or vapor deposition. As a further method, it is also possible to adopt a mode in which a nozzle plate 10 having the nozzles 12 is manufactured by electroforming, and the liquid-repelling film 14 is formed on this plate by coating or eutectic plating. Since various other methods can also be chosen, the appropriate method should be employed in view of the required accuracy, costs and other factors.

Step 2: Step of Removing a Portion of the Liquid-Repelling Film at the Periphery of the Nozzles in Order to Improve Wetting Properties in that Portion

Next, as illustrated in FIG. 18B, a portion of the liquid-repelling film 14 about the periphery of each nozzle 12 (the portion where the projecting section is to be formed subsequently) is removed. The removed portions 16 have better wetting properties than the portion where the liquid-repelling film 14 is still present.

As a method of removing a portion of the liquid-repelling film 14, for example, there is a mode in which the film is removed with laser light, or a mode where the area other than the portion for removal is masked, and the film is removed by plasma processing (using an oxygen plasma, or the like), or by irradiation of ultraviolet light. For the laser light source, it is possible to select one of various types of laser light source, such as an excimer laser, a carbon dioxide (CO₂) laser, a YAG laser, or the like. In a mode of carrying out plasma processing or irradiation of ultraviolet light, by irradiating an oxygen plasma or ultraviolet light via a mask member which has an opening in a position corresponding to the portion for removal, the portion of the liquid-repelling film which is exposed via the opening is removed. If the film is removed by laser, a merit is obtained in that no masking member is required. On the other hand, if an oxygen plasma or ultraviolet light is used, then a mask member must be fabricated and aligned with the nozzles 12, but a merit is obtained in that batch processing can be carried out over a single surface. The most efficient method should be selected in view of the size of the nozzle plate and the production volume, amongst other factors.

Furthermore, as a method of improving the wetting properties of one portion (rendering the portion more liquid-wettable) other than a mode which removes a portion of the liquid-repelling film 14, there is a mode in which the liquid-repelling film 14 is modified partially (FIG. 18C) or a method where an intermediate film (not illustrated) is provided so as to cover the resin in the locations where it is wished to apply the resin.

Reference numeral 17 in FIG. 18C represents a modified portion of the liquid-repelling film 14. As a means of selectively modifying a portion of the liquid-repelling film 14, for example, it is possible to employ oxygen plasma processing using a mask member 26.

Step 3: Step of Depositing Resin on Portion where Liquid-Repelling Film has been Removed (Portion which has been Modified so as to Improve Wetting Properties)

Following Step 2 which is described above, resin 30 is deposited onto the removed portions 16 (or the modified portions 17) of the liquid-repelling film 14, as illustrated in FIG. 518D. The means of depositing the resin 30 may employ a mode where a resin in liquid form is applied by a dispenser, or a mode where liquid droplets of resin are deposited by being ejected from an inkjet type of ejection head, or the like. It is also possible to apply resin onto a medium such as a sheet, and to then deposit the resin only onto the portions having good wetting properties, by transferring the resin to the nozzle plate 10 by means of the sheet. This method has benefits in that it enables simultaneous processing of one surface, but there is a possibility that problems may occur, such as resin being left on the liquid-repelling film 14, or resin entering inside the nozzles 12, and therefore countermeasures have to be taken, such as previously introducing a filler into the nozzles, or the like.

Furthermore, there is also a method whereby the nozzle plate is immersed in a resin liquid, but although this method similarly allows simultaneous processing of one surface, it also requires measures for introducing the filler into the nozzles, since otherwise the resin will enter into the nozzles.

Apart from this, there is also a method which deposits resin by means of a screen printing technique. This method enables one surface to be processed simultaneously, but it requires a mask in order to apply the resin selectively only to those portions where it is needed.

For the resin 30 which is deposited in Step 3 above, a resin material which can be cured in the subsequent step, Step 4, such as a thermally curable resin or a photo-curable resin, or the like, is used. For example, in the case of an ink ejection head, from the viewpoint of resistance to the ink, or the like, an epoxy type of resin is desirable, and a photo-curable epoxy resin, or a so-called epoxy type of negative resist, can be used. Examples of specific products are: SU-8 made by Kayaku Microchem Co., Ltd. (in particular, the SU-8 3000 series of chemically-amplified negative resists for forming permanent films), or a TMMR™ S2000 MEMS durable photoresist made by Tokyo Ohka Kogyo Co., Ltd., or the like. In terms of ink resistance, polyimide is a possible option, but this requires heat treatment at a high temperature.

### Step 4: Step of Curing the Resin

Next, processing is carried out to cure the resin 30 which has been deposited by Step 3 described above. If a photo-curable resin is used, then light which is suited to the curing action of the resin is irradiated and if a thermally curable resin is used, then heating to a temperature which is suited to the curing action of the resin is carried out. By curing the resin 30, a projecting section 30 is formed as cured resin on the periphery of the nozzle, and this projecting section 30 forms a step section which protects the nozzle 12.

If a photo-curable resin is used, then heating is not necessary and therefore, for example, even if the nozzle plate has already been assembled in a head, it is possible to carry out curing without giving rise to damage to the head or warping due to the difference between the coefficients of thermal expansion of the members. Consequently, a more desirable mode is one in which a photo-curable resin is used rather than a heat-curable resin.

By forming a projecting section 30 by means of the method of manufacture according to the present embodiment which passes through steps 1 to 4 described above, the action and beneficial effects described below are obtained.

(1) Since the resin is formed in a rounded shape (see FIG. 18D) due to the surface tension of the resin before it is cured, then a projecting section 30 having a rounded shape (projecting section structure) is obtained when this resin is cured. Therefore, even if a wiper (cleaning wiper) abuts against the rounded projecting section 30 when the ejection surface is wiped, damage is not caused to the wiper and there is little damage to the projecting section of the resin 30.

In this respect, if the projecting section is made of metal and is formed to a shape comprising an angle as described in Japanese Patent Application Publication No. 09-099558, then there is a possibility that the wiper (cleaning wiper) will be cut. Furthermore, not only does the wiper receive damage, but there is also a drawback in that the ejection action is adversely affected if cut shards of the wiper enter into the nozzles 12. These technical problems are resolved by the above-described embodiments of the present invention.

(2) If the resin becomes detached due to the paper striking against the projecting sections of resin in the event of a paper jam, or during a wiping action, or the like, then it is possible to repair the resin simply by recoating and curing the resin again. This means that the resin can be repaired simply and inexpensively.

The dimensions (width W, height h, and distance d from the nozzle 12) of the projecting sections 30 are decided from experimentation into the damage to the nozzles and the ink removal properties, on the basis of the hardness of the blade during wiping, the wiping conditions, the dimensions such as the nozzle diameter, the nozzle pitch, and the like.

If projecting sections having a broken line shape or an island shape are formed, then there are no portions where the lines overlap (intersect) with each other. When projecting sections are formed in a lattice configuration and there are portions where the respective lines overlap (intersect) with each other, then if lines are created by using a dispenser, then the (intersect) portions are written twice, and hence the height of the projecting sections 30 corresponding to the portions rises up, and damage is more likely to be caused by the wiper during the wiping operation.

On the other hand, if resin is deposited using a mask (by a method such as screen printing), it is difficult to form a mask in continuous straight lines (the strength of the mask declines), and therefore broken lines are desirable.

In the case of the projecting section 30 composed of resin described in FIGS. 18A to 19C, the liquid-repelling properties of the resin itself are inferior to those of the liquid-repelling film 14, and therefore the liquid-wetting properties are relatively higher. It is also possible to make use of this wettability to improve the liquid removal properties in the vicinity of the nozzles.

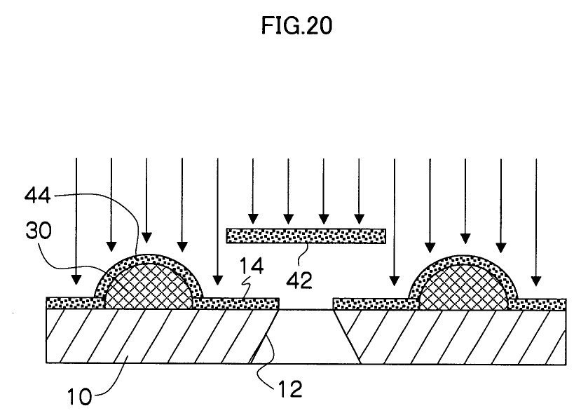

Meanwhile, if the ink removal properties during wiping are problems (namely, if liquid is liable to be left about the periphery of the projecting section 30), then as illustrated in FIG. 20, the portion of the nozzles 12 should be concealed with a mask member 42 (for example, a metal mask), and the liquid-repelling film 44 should be formed by a method such as vapor deposition, for instance. By so doing, a liquid-repelling film 44 is also formed on the projecting section 30 of the resin, and hence the ink removal properties of the whole nozzle plate are improved.

There may also be a case where, depending on the material of the liquid-repelling film 44, a further liquid-repelling film 44 may be formed additionally on the liquid-repelling film 14 in the portions apart from the projecting section 30 of the resin, but normally, due to the liquid-repelling properties of the liquid-repelling film 14, it is difficult to form a further liquid-repelling film 44 on top of the liquid-repelling film 14. In this case, a liquid-repelling film 44 is formed only on the projecting section 30 of the resin.

In the method of manufacture described in FIGS. 18A to 19C, it is stated that after forming a liquid-repelling film 14 uniformly on the ejection surface side of the nozzle plate 10, a portion of that film is removed or modified (FIGS. 18B and 18C), but it is also possible to adopt a mode in which portions where liquid-repelling film is formed and portions where liquid-repelling film is not formed are patterned when the liquid-repelling film 14 is formed, rather than carrying out a staged process of this kind. In other words, when forming a liquid-repelling film, the liquid-repelling film is deposited in such a manner that it is not present in the portions where the resin is to be deposited in a later stage.

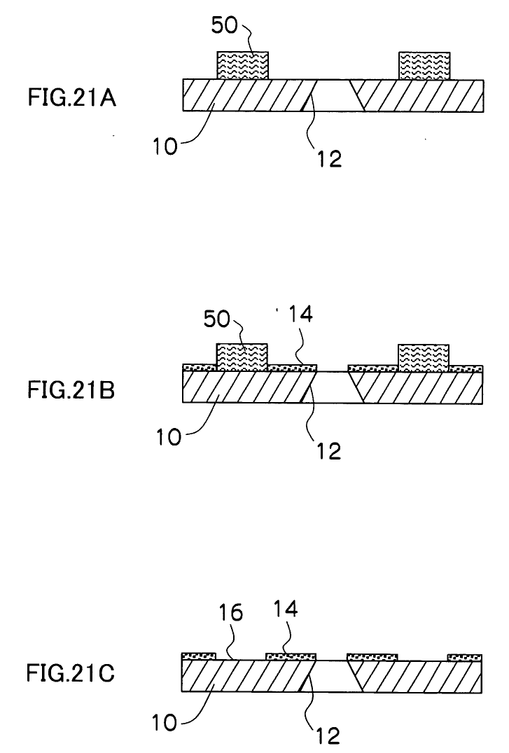

FIGS. 21A to 21C are step diagrams illustrating an example where patterning is carried out during the formation of the liquid-repelling film.

Firstly, as illustrated in FIG. 21A, a resist (photosensitive resin) 50 is formed on the ejection surface side of a nozzle plate 10 in which nozzles 12 are formed, onto the portions where it is wished to deposit resin 30 in a later step.

Thereupon, a liquid-repelling film 14 is formed by eutectic plating, vapor deposition, or the like (FIG. 21B), and the resist 50 is then removed (FIG. 21C).

According to this method of manufacture, although the step of patterning the resist 50 is added, the step of removing the liquid-repelling film 14 is eliminated. Furthermore, when the liquid-repelling film 14 is removed subsequently, if the film is not removed satisfactorily, then there is a possibility that it becomes difficult to deposit resin in the later stage, but according to the method of manufacture described in FIGS. 21A to 21C, it is possible reliably to form a portion where there is no liquid-repelling film. However, in order to form a liquid-repelling film 14 on a substrate where resist 50 has been formed (FIG. 21B), it is necessary to match the resist material with the method of forming the liquid-repelling film, and hence there are liable to be restrictions on the method which can be employed to form the liquid-repelling film.

Furthermore, if the portion on the substrate where the resin is to be deposited is roughened, then the adhesiveness of the resin is improved. The portion where resin is to be deposited can be roughened before depositing resin, or alternatively, the whole surface of the substrate (the ejection surface side thereof) can be roughened before forming the liquid-repelling film 14.

Since it is relatively difficult to carry out processing for roughening the substrate in a partial fashion after forming a liquid-repelling film, a desirable mode is one where the surface of the substrate is roughened before forming the liquid-repelling film. If the surface of the substrate is roughened before forming the liquid-repelling film, then a merit is obtained in that the adhesiveness of the liquid-repelling film itself is also improved. As the device for roughening the surface of the substrate, it is possible to use blast processing, etching, or the like.

The methods of manufacturing projecting sections of a nozzle plate relating to the respective embodiments described above can be carried out after a nozzle plate 10 formed with nozzles 12 has been assembled in a head. Consequently, it is also possible to select an optimum process until the assembly of the head, and it is easy to repair, restore, replace, etc. the projecting sections after the manufacture of the head. When repairing or restoring the projecting sections, it is also possible to restore damaged portions in a localized fashion, and it is also possible to remove all or a portion of the projecting sections and then reform same.

Of course, the methods of manufacturing projecting sections of a nozzle plate according to the respective embodiments can employ similar steps in respect of the nozzle plate 10 before the assembly thereof in the head, and hence they can be used in a method of manufacturing a nozzle plate.

First example of composition of inkjet recording apparatus Next, an example of an image forming apparatus which uses the inkjet head comprising the nozzle plate described above will be explained.

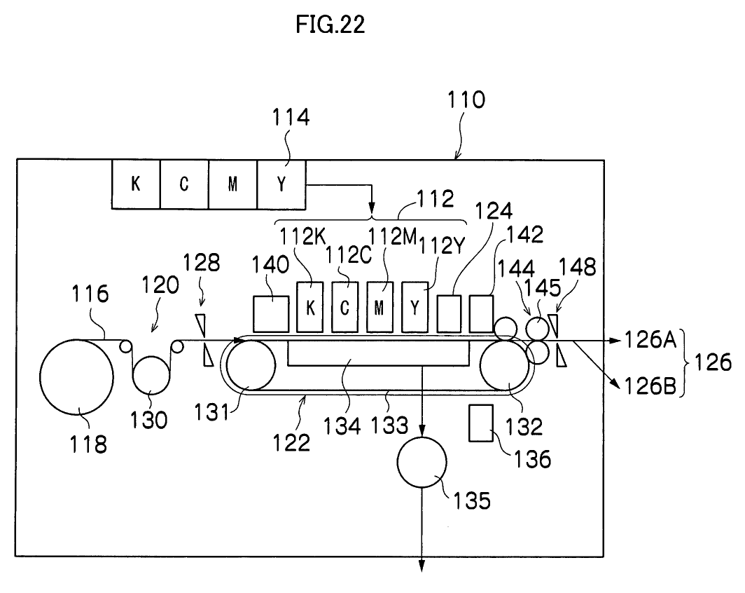

FIG. 22 is a general configuration diagram of an inkjet recording apparatus including an image forming apparatus according to an embodiment of the present invention. As illustrated in FIG. 22, the inkjet recording apparatus 110 comprises: a print unit 112 having a plurality of inkjet recording heads (hereafter, called “heads”) 112K, 112C, 112M, and 112Y provided for ink colors of black (K), cyan (C), magenta (M), and yellow (Y), respectively; an ink storing and loading unit 114 for storing inks to be supplied to the print heads 112K, 112C, 112M, and 112Y; a paper supply unit 118 for supplying recording paper 116 which is a recording medium; a decurling unit 120 removing curl in the recording paper 116; a belt conveyance unit 122 disposed facing the nozzle face (ink-droplet ejection face) of the print unit 112, for conveying the recording paper 116 while keeping the recording paper 116 flat; a print determination unit 124 (corresponding to a determination device) for reading the printed result produced by the print unit 112; and a paper output unit 126 for outputting image-printed recording paper (printed matter) to the exterior.

The ink storing and loading unit 114 has ink tanks for storing the inks corresponding to the heads 112K, 112C, 112M, and 112Y, and the tanks are connected to the heads 112K, 112C, 112M, and 112Y by means of prescribed channels. The ink storing and loading unit 114 has a warning device (for example, a display device or an alarm sound generator) for warning when the remaining amount of any ink is low, and has a mechanism for preventing loading errors among the colors.

In FIG. 22, a magazine for rolled paper (continuous paper) is illustrated as an example of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording media can be used, it is desirable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine. The heating temperature at this time is desirably controlled so that the recording paper 116 has a curl in which the surface on which the print is to be made is slightly round outward.

In the case of the configuration in which roll paper is used, a cutter (first cutter) 128 is provided as illustrated in FIG. 22, and the continuous paper is cut into a desired size by the cutter 128. When cut papers are used, the cutter 128 is not required.

The decurled and cut recording paper 116 is delivered to the belt conveyance unit 122. The belt conveyance unit 122 has a configuration in which an endless belt 133 is set around rollers 131 and 132 so that the portion of the endless belt 133 facing at least the nozzle face of the print unit 112 and the sensor face of the print determination unit 124 forms a horizontal plane (flat plane).

The belt 133 has a width that is greater than the width of the recording paper 116, and a plurality of suction apertures (not illustrated) are formed on the belt surface. A suction chamber 134 is disposed in a position facing the sensor surface of the print determination unit 124 and the nozzle surface of the print unit 112 on the interior side of the belt 133, which is set around the rollers 131 and 132, as illustrated in FIG. 22. The suction chamber 134 provides suction with a fan 135 to generate a negative pressure, and the recording paper 116 is held on the belt 133 by suction. It is also possible to use an electrostatic attraction method, instead of a suction-based attraction method.

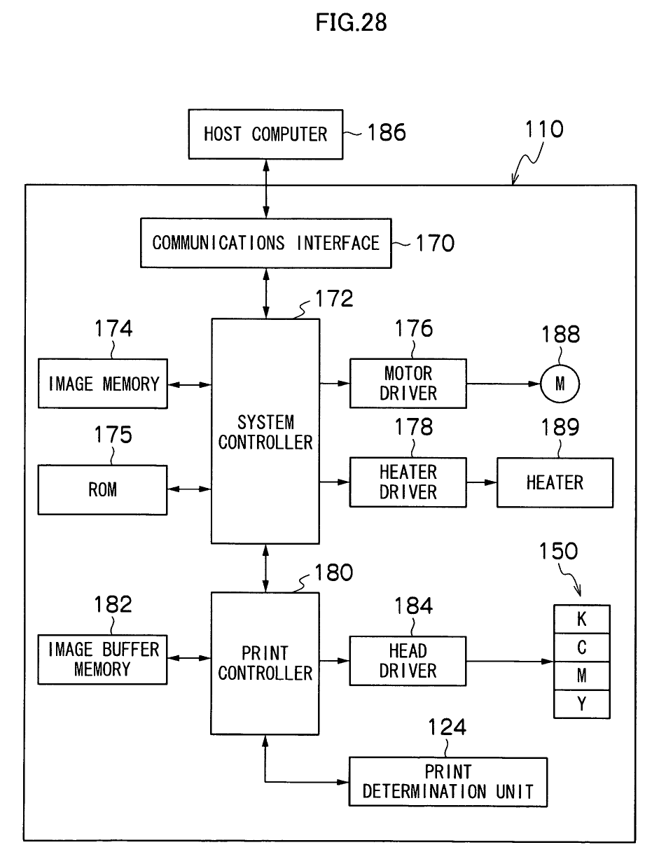

The belt 133 is driven in the clockwise direction in FIG. 22 by the motive force of a motor 188 (illustrated in FIG. 28) being transmitted to at least one of the rollers 131 and 132, which the belt 133 is set around, and the recording paper 116 held on the belt 133 is conveyed from left to right in FIG. 22.

Since ink adheres to the belt 133 when a marginless print job or the like is performed, a belt-cleaning unit 136 is disposed in a predetermined position (a suitable position outside the printing area) on the exterior side of the belt 133. Although the details of the configuration of the belt-cleaning unit 136 are not illustrated, examples thereof include a configuration in which the belt 133 is nipped with cleaning rollers such as a brush roller and a water absorbent roller, an air blow configuration in which clean air is blown onto the belt 133, or a combination of these. In the case of the configuration in which the belt 133 is nipped with the cleaning rollers, it is desirable to make the line velocity of the cleaning rollers different from that of the belt 133 to improve the cleaning effect.

The inkjet recording apparatus 110 can comprise a roller nip conveyance mechanism, instead of the belt conveyance unit 122. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is desirable.

A heating fan 140 is disposed on the upstream side of the print unit 112 in the conveyance pathway formed by the belt conveyance unit 122. The heating fan 140 blows heated air onto the recording paper 116 to heat the recording paper 116 immediately before printing so that the ink deposited on the recording paper 116 dries more easily.

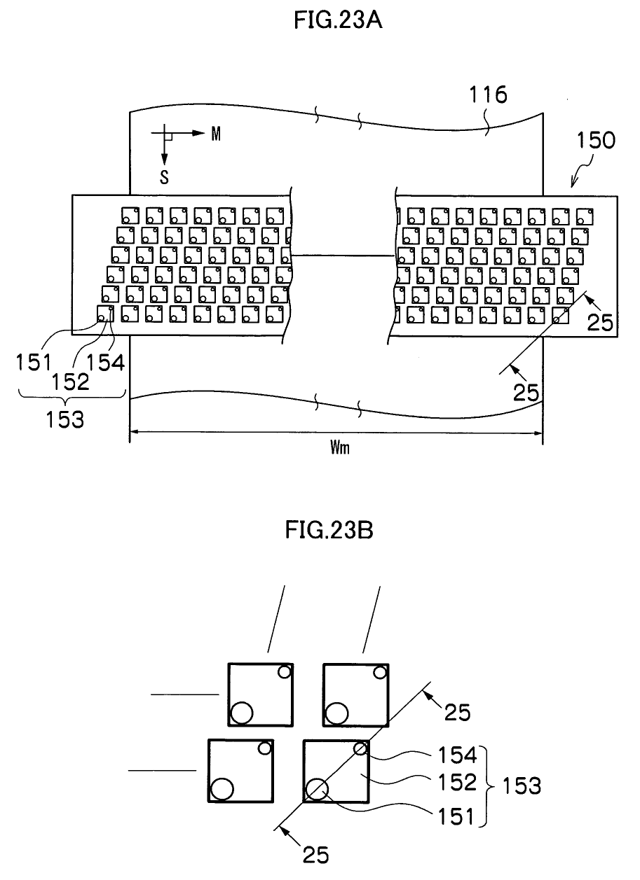

The heads 112K, 112C, 112M and 112Y of the print unit 112 are full line heads having a length corresponding to the maximum width of the recording paper 116 used with the inkjet recording apparatus 110, and comprising a plurality of nozzles for ejecting ink arranged on a nozzle face through a length exceeding at least one edge of the maximum-size recording medium (namely, the full width of the printable range) (see FIGS. 23A and 23B).

The print heads 112K, 112C, 112M and 112Y are arranged in color order (black (K), cyan (C), magenta (M), yellow (Y)) from the upstream side in the feed direction of the recording paper 116, and these respective heads 112K, 112C, 112M and 112Y are fixed extending in a direction substantially perpendicular to the conveyance direction of the recording paper 116.

A color image can be formed on the recording paper 116 by ejecting inks of different colors from the heads 112K, 112C, 112M and 112Y, respectively, onto the recording paper 116 while the recording paper 116 is conveyed by the belt conveyance unit 122.

By adopting a configuration in which the full line heads 112K, 112C, 112M and 112Y having nozzle rows covering the full paper width are provided for the respective colors in this way, it is possible to record an image on the full surface of the recording paper 116 by performing just one operation of relatively moving the recording paper 116 and the print unit 112 in the paper conveyance direction (the sub-scanning direction), in other words, by means of a single sub-scanning action (this type of recording method is called a single-pass method). Higher-speed printing is thereby made possible and productivity can be improved in comparison with a shuttle (serial) scan type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 124 illustrated in FIG. 22 has an image sensor (line sensor or area sensor) for capturing an image of the droplet ejection result of the print unit 112, and functions as a device to check the ejection characteristics, such as blockages, landing position error, and the like, of the nozzles, on the basis of the image of ejected droplets read in by the image sensor. A test pattern or the target image printed by the print heads 112K, 1112C, 112M, and 112Y of the respective colors is read in by the print determination unit 124, and the ejection performed by each head is determined. The ejection determination includes detection of the ejection, measurement of the dot size, and measurement of the dot formation position.

A post-drying unit 142 is disposed following the print determination unit 124. The post-drying unit 142 is a device to dry the printed image surface, and includes a heating fan, for example. It is desirable to avoid contact with the printed surface until the printed ink dries, and a device that blows heated air onto the printed surface is desirable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test print are desirably outputted separately. In the inkjet recording apparatus 110, a sorting device (not illustrated) is provided for switching the outputting pathways in order to sort the printed matter with the target print and the printed matter with the test print, and to send them to paper output units 126A and 126B, respectively. When the target print and the test print are simultaneously formed in parallel on the same large sheet of paper, the test print portion is cut and separated by a cutter (second cutter) 148. Although not illustrated in FIG. 22, the paper output unit 126A for the target prints is provided with a sorter for collecting prints according to print orders.

### Structure of Head

Next, the structure of a head will be described. The heads 112K, 112C, 112M and 112Y of the respective ink colors have the same structure, and a reference numeral 150 is hereinafter designated to any of the heads.

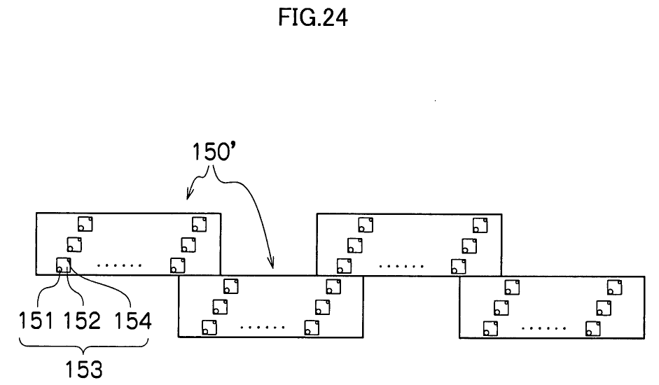

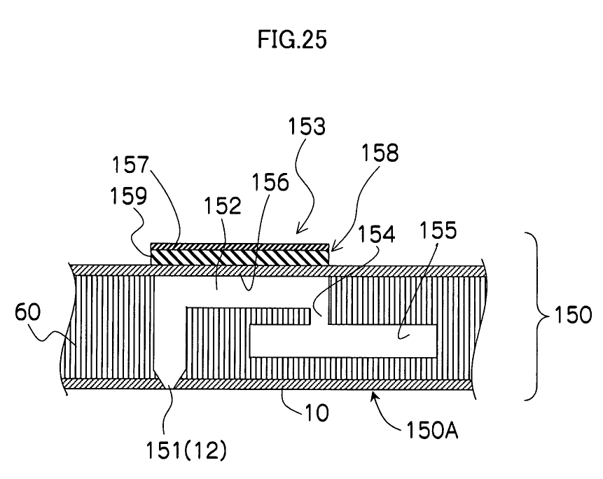

FIG. 23A is a perspective plan view illustrating an example of the configuration of the head 150, FIG. 23B is an enlarged view of a portion thereof, FIG. 24 is a perspective plan view illustrating another example of the configuration of the head 150, and FIG. 25 is a cross-sectional view taken along line 25-25 in FIGS. 23A and 23B, illustrating the inner structure of a droplet ejection element of one channel constituting a recording element unit (an ink chamber unit for one nozzle 151).

The nozzle pitch in the head 150 should be minimized in order to maximize the density of the dots printed on the surface of the recording paper 116. As illustrated in FIGS. 23A and 23B, the head 150 according to the present embodiment has a structure in which a plurality of ink chamber units (droplet ejection elements) 153, each comprising a nozzle 151 forming an ink ejection port, a pressure chamber 152 corresponding to the nozzle 151, and the like, are disposed two-dimensionally in the form of a staggered matrix, and hence the effective nozzle interval (the projected nozzle pitch) as projected (orthogonal projection) in the lengthwise direction of the head (the direction perpendicular to the paper conveyance direction) is reduced and high nozzle density is achieved.

The mode of forming nozzle rows of a length greater than the length corresponding to the entire width Wm of the recording paper 116 in a direction (the direction indicated by arrow M; the main-scanning direction) substantially perpendicular to the conveyance direction of the recording paper 116 (the direction indicated by arrow S; the sub-scanning direction) is not limited to the example described above. For example, instead of the configuration in FIG. 23A, as illustrated in FIG. 12, a line head having nozzle rows of a length corresponding to the entire width of the recording paper 116 can be formed by arranging and combining, in a staggered matrix, short head modules 150′ having a plurality of nozzles 151 arrayed in a two-dimensional fashion.

As illustrated in FIGS. 23A and 23B, the planar shape of the pressure chamber 152 provided for each nozzle 151 is substantially a square, and an outlet to the nozzle 151 is provided in one of corners on a diagonal line of the square, and an inlet of supplied ink (supply port) 154 is provided in the other corner. The shape of the pressure chamber 152 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

As illustrated in FIG. 25, the head 150 is formed by a structure in which a nozzle plate 10, a flow channel plate 60, a diaphragm 156, and the like, are laminated and bonded together.

In the nozzle plate 10 according to the present embodiment, projecting sections (not illustrated in FIG. 25, see reference numeral 30 in FIGS. 1A and 1B) and a liquid-repelling film are formed on the ejection side surface by using a method of manufacture detailed above. This nozzle plate 10 forms the nozzle surface (ink ejection surface) 150A of the head 150, and a plurality of nozzles 151 which are respectively connected to the pressure chambers 152 are formed in a two-dimensional configuration in the nozzle plate 10.

The flow channel plate 60 is a flow channel forming member which constitutes the side wall sections of the pressure chambers 152, and forms a supply port 154 constituting a restrictor section (narrowest section) of the independent supply channel that guides ink from the common flow channel 155 into the pressure chamber 152. For the purpose of the to description, FIG. 25 illustrates a simplified depiction, but the flow channel 60 in fact has a structure in which one or a plurality of substrates are laminated together.

As well as forming one side surface of the pressure chambers 152 (the upper surface in FIG. 25), the diaphragm 156 is made of a conductive material such as stainless steel (SUS) or silicon (Si) with a nickel (Ni) conductive layer, or the like, and therefore also serves as a common electrode for the plurality of actuators (here, the piezoelectric elements) 158 which are disposed so as to correspond to the respective pressure chambers 152. A mode is also possible in which a diaphragm is formed by a non-conductive material, such as resin, and in this case, a common electrode layer made of a conductive material, such as metal, is formed on the surface of the diaphragm member.

A piezoelectric body 159 is provided on the surface of the diaphragm 156 on the side opposite to the pressure chambers 152 (the upper side in FIG. 25) at each position corresponding to the pressure chambers 152, and an individual electrode 157 is formed on the upper surface of the piezoelectric body 159 (the surface of the piezoelectric body 159 on the side opposite to the surface in contact with the diaphragm 156 which also serves as a common electrode). A piezoelectric element which functions as an actuator 158 is constituted by the individual electrode 157, the common electrode opposing same (in the present embodiment, this also doubles as the diaphragm 156), and the piezoelectric body 159 which is interposed between these two electrodes. As the material of the piezoelectric body 159, it is desirable to use a piezoelectric material, such as lead titanate zirconate, barium titanate, or the like.

Each pressure chamber 152 is connected to a common channel 155 through the supply port 154. The common channel 155 is connected to an ink tank (not illustrated), which is a base tank that supplies ink, and the ink supplied from the ink tank is delivered through the common flow channel 155 to the pressure chambers 152.

When a drive voltage is applied to the individual electrode 157 of the actuator 158 and the common electrode, the actuator 158 deforms, thereby changing the volume of the pressure chamber 152. This causes a pressure change which results in ink being ejected from the nozzle 151. When the displacement of the actuator 158 returns to its original position after ejecting ink, the pressure chamber 152 is supplied with new ink from the common flow channel 155, via the supply port 154.

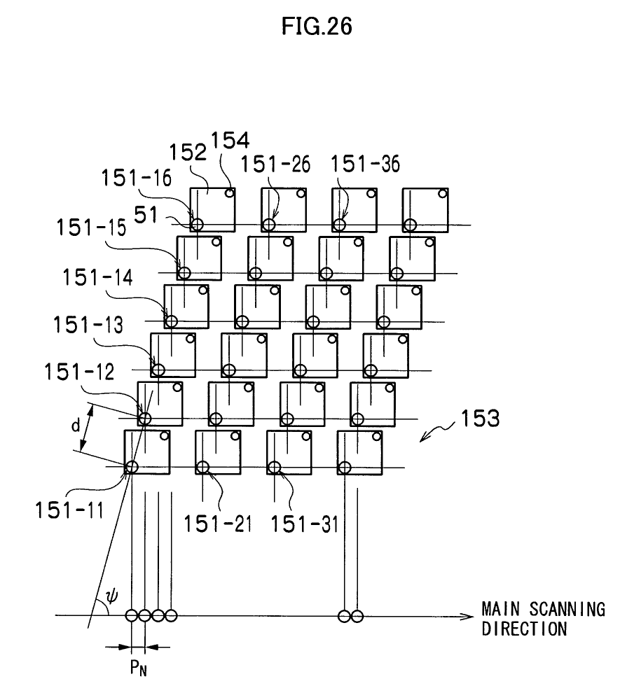

As illustrated in FIG. 26, the high-density nozzle head according to the present embodiment is achieved by arranging a plurality of ink chamber units 153 having the above-described structure in a lattice fashion based on a fixed arrangement pattern, in a row direction which coincides with the main scanning direction, and a column direction which is inclined at a fixed angle of ψ with respect to the main scanning direction, rather than being perpendicular to the main scanning direction.

More specifically, by adopting a structure in which a plurality of ink chamber units 153 are arranged at a uniform pitch d in line with a direction forming an angle of ψ with respect to the main scanning direction, the pitch PN of the nozzles projected so as to align in the main scanning direction is d×cos ψ, and hence the nozzles 151 can be regarded to be substantially equivalent to those arranged linearly at a fixed pitch PN along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 151 arranged in a matrix such as that illustrated in FIG. 26 are driven, the main scanning according to the above-described (3) is preferred. More specifically, the nozzles 151-11, 151-12, 151-13, 151-14, 151-15 and 151-16 are treated as a block (additionally; the nozzles 151-21, 151-22, . . . , 151-26 are treated as another block; the nozzles 151-31, 151-32, . . . , 151-36 are treated as another block; . . . ); and one line is printed in the width direction of the recording paper 116 by sequentially driving the nozzles 151-11, 151-12, . . . , 151-16 in accordance with the conveyance velocity of the recording paper 116.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other.

The direction indicated by one line (or the lengthwise direction of a band-shaped region) recorded by the main scanning as described above is called the “main scanning direction”, and the direction in which sub-scanning is performed, is called the “sub-scanning direction”. In other words, in the present embodiment, the conveyance direction of the recording paper 116 is called the sub-scanning direction and the direction perpendicular to same is called the main scanning direction.

In implementing the present invention, the arrangement of the nozzles is not limited to that of the example illustrated. Moreover, a method is employed in the present embodiment where an ink droplet is ejected by means of the deformation of the actuator, which is typically a piezoelectric element; however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

### Configuration of Ink Supply System

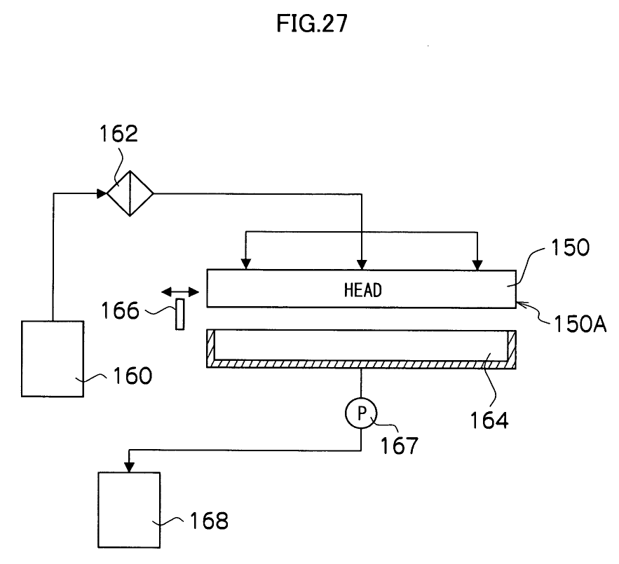

FIG. 27 is a schematic drawing illustrating the configuration of the ink supply system in the inkjet recording apparatus 110. The ink tank 160 is a base tank that supplies ink to the head 150 and is set in the ink storing and loading unit 114 described with reference to FIG. 22. In other words, the ink tank 160 in FIG. 27 is equivalent to the ink storage and loading unit 114 in FIG. 22. The aspects of the ink tank 160 include a refillable type and a cartridge type: when the remaining amount of ink is low, the ink tank 160 of the refillable type is filled with ink through a filling port (not illustrated) and the ink tank 160 of the cartridge type is replaced with a new one. In order to change the ink type in accordance with the intended application, the cartridge type is suitable, and it is desirable to represent the ink type information with a bar code or the like on the cartridge, and to perform ejection control in accordance with the ink type.

A filter 162 for removing foreign matters and bubbles is disposed between the ink tank 160 and the head 150 as illustrated in FIG. 27. The filter mesh size of the filter 162 is desirably equivalent to or less than the diameter of a nozzle. Although not illustrated in FIG. 27, it is desirable to provide a sub-tank integrally to the print head 150 or nearby the head 150. The sub-tank has a damper function for preventing variation in the internal pressure of the head and a function for improving refilling of the print head.

The inkjet recording apparatus 110 is also provided with a cap 164 as a device to prevent the nozzles 151 from drying out or to prevent an increase in the ink viscosity in the vicinity of the nozzles 151, and a cleaning wiper 166 as a device to clean the nozzle face 150A. A maintenance unit (restoration device) including the cap 164 and the cleaning wiper 166 can be relatively moved with respect to the head 150 by a movement mechanism (not illustrated), and is moved from a predetermined holding position to a maintenance position below the head 150 as required.

The cap 164 is displaced up and down relatively with respect to the head 150 by an elevator mechanism (not illustrated). When the power of the inkjet recording apparatus 110 is turned OFF or when in a print standby state, the cap 164 is raised to a predetermined elevated position so as to come into close contact with the head 150, and the nozzle face 150A is thereby covered with the cap 164.

The cleaning wiper 166 is composed of rubber or another elastic member, and can slide on the nozzle surface 150A (surface of the nozzle plate) of the head 150 by means of a wiper movement mechanism (not illustrated). When ink droplets or foreign matter has adhered to the surface of the nozzle plate, the nozzle surface is wiped by sliding the cleaning wiper 166 on the nozzle plate.

During printing or standby, when the frequency of use of specific nozzles is reduced and ink viscosity increases in the vicinity of the nozzles, a preliminary discharge (dummy ejection operation) is made to eject the degraded ink toward the cap 164 (which also serves as an ink receptacle).

When a state in which ink is not ejected from the head 150 continues for a certain amount of time or longer, the ink solvent in the vicinity of the nozzles 151 evaporates and ink viscosity increases. In such a state, ink can no longer be ejected from the nozzle 151 even if the actuator 158 for the ejection driving is operated. Before reaching such a state (in a viscosity range that allows ejection by the operation of the actuator 158) the actuator 158 is operated to perform the preliminary discharge to eject the ink whose viscosity has increased in the vicinity of the nozzle toward the ink receptor.

After the nozzle surface is cleaned by a wiper such as the cleaning wiper 166 provided as the cleaning device for the nozzle face 150A, a preliminary discharge is also carried out in order to prevent the foreign matter from becoming mixed inside the nozzles 151 by the wiper sliding operation.

On the other hand, if air bubbles become intermixed into a nozzle 151 or a pressure chamber 152, or if the rise in the viscosity of the ink inside a nozzle 151 exceeds a certain level, then it may not be possible to eject ink in the dummy ejection operation described above. In cases of this kind, the cap 164 forming a suction device is pressed against the nozzle surface 150A of the print head 150, and the ink inside the pressure chambers 152 (namely, the ink containing air bubbles of the ink of increased viscosity) is suctioned by a suction pump 167. The ink suctioned and removed by means of this suction operation is sent to a recovery tank 168. The ink collected in the recovery tank 168 may be used, or if reuse is not possible, it may be discarded.

Since the suctioning operation is performed with respect to all of the ink in the pressure chambers 152, it consumes a large amount of ink, and therefore, desirably, restoration by preliminary ejection is carried out while the increase in the viscosity of the ink is still minor. The suction operation is also carried out when ink is loaded into the print head 150 for the first time, and when the head starts to be used after being idle for a long period of time.

### Description of Control System

FIG. 28 is a block diagram illustrating a system composition of the inkjet recording apparatus 110. As illustrated in FIG. 28, the inkjet recording apparatus 110 comprises a communications interface 170, a system controller 172, an image memory 174, a ROM 175, a motor driver 176, a heater driver 178, a print controller 180, an image buffer memory 182, a head driver 184, and the like.

The communications interface 170 is an interface unit (image data input device) for receiving image data which is transmitted by a host computer 186. For the communications interface 170, a serial interface, such as USB (Universal Serial Bus), IEEE 1394, an Ethernet (registered tradename), or a wireless network, or the like, or a parallel interface, such as a Centronics interface, or the like, can be used. It is also possible to install a buffer memory (not illustrated) for achieving high-speed communications.

Image data sent from the host computer 186 is read into the image forming apparatus 110 via the communications interface 170, and is stored temporarily in the image memory 174. The image memory 174 is a storage device which stores an image input via the communications interface 170, and data is read from and written to the image memory 174 via the system controller 172. The image memory 174 is not limited to being a memory composed of a semiconductor element, and may also use a magnetic medium, such as a hard disk.

The system controller 172 is constituted by a central processing unit (CPU) and peripheral circuits thereof, and the like, and functions as a control apparatus which controls the whole of the inkjet recording apparatus 110 in accordance with prescribed programs, as well as functioning as a calculation apparatus which carries out various calculations. In other words, the system controller 172 controls the various units, such as the communications interface 170, the image memory 174, the motor driver 176, the heater driver 178, and the like, and controls communications with the host computer 186 as well as controlling the reading and writing of data to the image memory 174 and the ROM 175, and furthermore, it also generates control signals for controlling the motor 188 of the conveyance system and the heater 189.

The ROM 175 stores programs which are executed by the CPU of the system controller 172 and various data required for control purposes (including data of the ejection waveform for image formation and the ejection waveform for dummy ejection), and the like. The ROM 175 may be a non-rewritable storage device, or it may be a writable storage device, such as and EEPROM. The ROM 175 according to the present embodiment is constituted by a rewritable EEPROM and also serves as a history information storage device which stores operating history information for each of the heads of the respective heads, and ejection history information for each nozzle.

The image memory 174 is used as a temporary storage region for the image data, and it is also used as a program development region and a calculation work region for the CPU.

The motor driver (drive circuit) 176 drives the motor 188 of the conveyance system in accordance with commands from the system controller 172. The heater driver (drive circuit) 178 drives the heater 189 of the post-drying unit 142 or the like in accordance with commands from the system controller 172.

The print controller 180 has a signal processing function for performing various tasks, compensations, and other types of processing for generating print control signals from the image data (original image data) stored in the image memory 174 in accordance with commands from the system controller 172 so as to supply the generated print data (dot data) to the head driver 184.

The print controller 180 according to the present embodiment generates drive control signals for the respective heads by combining the ejection waveform for image formation and the ejection waveform for dummy ejection which are stored in the ROM 175, and the image data for recording. For example, the data for dummy ejection is inserted in the blank portions between images in the image forming waveform data of the images that are to be recorded. Alternatively, dummy ejection data is inserted in a dispersed fashion within the image forming waveform data of an image that is to be recorded, according to a prescribed rule which avoids affecting the formed image.

The image buffer memory 182 is provided with the print controller 180, and image data, parameters, and other data are temporarily stored in the image buffer memory 182 when image data is processed in the print controller 180. FIG. 28 illustrates a mode in which the image buffer memory 182 is attached to the print controller 180; however, the image memory 174 may also serve as the image buffer memory 182. Also possible is a mode in which the print controller 180 and the system controller 172 are integrated to form a single processor.

To give a general description of the sequence of processing from image input to print output, image data to be printed is input from an external source via the communications interface 170, and is accumulated in the image memory 174. At this stage, RGB image data is stored in the image memory 174, for example.

In this inkjet recording apparatus 110, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal gradations of the image (namely, the light and shade toning of the image) as faithfully as possible. Therefore, original image data (RGB data) stored in the image memory 174 is sent to the print controller 180 through the system controller 172, and is converted to the dot data for each ink color by a half-toning technique, using a threshold value matrix, error diffusion, or the like, in the print controller 180.

In other words, the print controller 180 performs processing for converting the input RGB image data into dot data for the four colors of K, C, M and Y. The dot data generated by the print controller 180 in this way is stored in the image buffer memory 182.

The head driver 184 outputs drive signals for driving the actuators 158 corresponding to the nozzles 151 of the head 150, on the basis of print data (in other words, dot data stored in the image buffer memory 182) supplied by the print controller 180. A feedback control system for maintaining constant drive conditions in the head may be included in the head driver 184.

By supplying the drive signals output by the head driver 184 to the print heads 150, ink is ejected from the corresponding nozzles 151. By controlling ink ejection from the print head 150 in synchronization with the conveyance speed of the recording paper 116, an image is formed on the recording paper 116.

As described above, the ejection volume and the ejection timing of the ink droplets from the respective nozzles are controlled via the head driver 184, on the basis of the dot data generated by implementing required signal processing in the print controller 180. By this means, desired dot size and dot positions can be achieved.

The print determination unit 124 is a block that includes the image sensor as described above with reference to FIG. 22, reads the image printed on the recording paper 116, determines the print conditions (presence of the ejection, variation in the dot formation, optical density, and the like) by performing required signal processing, or the like, and provides the determination results of the print conditions to the print controller 180 and the system controller 172.

The print controller 180 implements various corrections with respect to the head 150, on the basis of the information obtained from the print determination unit 124, according to requirements, and it implements control for carrying out cleaning operations (nozzle restoring operations), such as preliminary ejection, suctioning, or wiping, as and when necessary.

For example, whenever an ejection defect is detected in the head 150 by the print determination unit 124, then the print controller 180 implements control in such a manner that preliminary ejection is carried out automatically. Alternatively, it is possible to adopt a mode in which, whenever an ejection defect of the head 150 has been determined by the print determination unit 124, control is implemented in such a manner that preliminary ejection is carried out automatically only in the head (112C, 112M, 112Y and 112K) where the ejection defect has been determined, or only in the nozzle row or the particular nozzle which is suffering an ejection defect in that head.

In the embodiment described above, the inkjet recording apparatus is based on a system which forms an image by ejecting ink droplets directly onto a recording medium, such as recording paper 116 (a direct recording method), but the scope of application of the present invention is not limited to this.

### Second Example of Composition of Inkjet Recording Apparatus

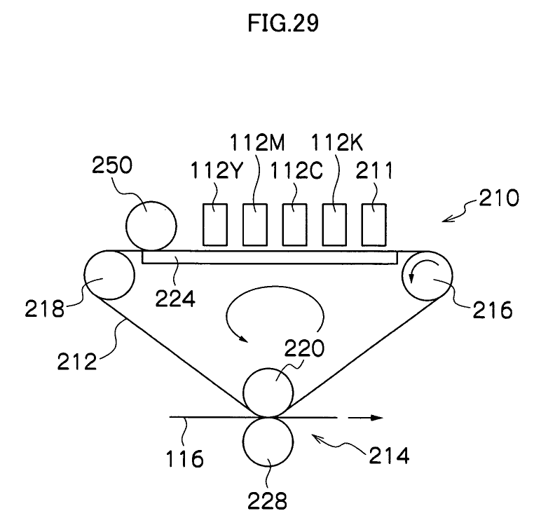

FIG. 29 is a principal schematic drawing illustrating a further example of the composition of the inkjet recording apparatus. The mode of the inkjet recording apparatus 210 illustrated in FIG. 29 is an image forming apparatus in which, rather than forming an image directly onto a recording medium, an image (primary image) is formed temporarily on an intermediate transfer body 212 and this image is then transferred onto recording paper 116 in a transfer unit 214, thereby creating a final image. In FIG. 29, elements which are the same as or similar to those in FIG. 22 are labeled with the same reference numerals and further explanation thereof is omitted here.

In the inkjet recording apparatus 210 illustrated in FIG. 29, an endless belt member is used as the intermediate transfer body 212. The intermediate transfer body 212 is made of a non-permeable medium (for example, a polyimide film, urethane rubber, silicone rubber, or the like). It is also possible to make only the layer on the front surface side of the intermediate transfer body 212 (the side on which the ink is deposited), from a non-permeable medium.

In FIG. 29, the intermediate transfer body 212 is composed so as to be wound about the exterior of three rollers 216, 218 and 220. The first roller 216 is a drive roller to which the motive force of the drive motor (not illustrated) is transmitted, and the other rollers (the second roller 218 and the third roller 220) are idle rollers which rotate due to the movement of the intermediate transfer body 212. When the first roller 216 rotates due to the driving of the drive motor, the intermediate transfer body 212 turns in the counter-clockwise direction in FIG. 29 (hereinafter, called the “direction of rotation of the transfer body”) due to this rotation.

A plurality of heads 112K, 112C, 112M and 112Y which correspond to the respective colors of black (K), cyan (C), magenta (M) and yellow (Y) are provided in sequence from the upstream side in the direction of rotation of the transfer body, at positions opposing the front surface (outer circumferential surface) of the intermediate transfer body 212, between the first roller 216 and the second roller 218. Furthermore, a treatment liquid ejection head 211 (which corresponds to the “treatment material ejection head”) for ejecting treatment liquid for promoting the aggregation or curing of ink coloring material (this treatment liquid corresponds to a “liquid material” that reduces the fluidity of the ink) is disposed to the upstream side of this group of heads of the respective colors of ink.

The treatment liquid ejection head 211 is also a full line type of line head which has a similar composition to the ink heads 112K, 112C, 112M and 112Y, and is able to record an image over the whole surface of the intermediate transfer body 212 by carrying out just one operation of moving the intermediate transfer body 212 and the heads (112K, 112C, 112M, 112Y and 211) relatively with respect to each other in the direction of rotation of the transfer body, without moving the heads (112K, 112C, 112M, 112Y and 211) in the breadthways direction of the intermediate transfer body 212. Therefore, it is possible to improve the recording speed.

Droplets of treatment liquid are ejected while being controlled to a required volume, in accordance with the image contents that are to be recorded. It is also possible to deposit treatment liquid only onto the droplet ejection positions which are created by dummy ejection.

A platen 224 which forms a supporting member for the intermediate transfer body 212 is disposed at a position opposing the heads (112K, 112C, 112M, 112Y and 211) on the other side of the intermediate transfer body 212 from same. Droplets are ejected from the respective heads in a state where the surface of the intermediate transfer body 212 is maintained in a flat shape at least at the position opposing the respective heads (112K, 1112C, 112M, 112Y and 211) by means of the platen 224.

A solvent removal roller 250 is disposed so as to make contact with the surface of the intermediate transfer body 212, on the downstream side of the yellow head 112Y in terms of the direction of rotation of the transfer body. The solvent removal roller 250 is a solvent removal device which removes excess solvent by making contact with the solvent of the ink that has been deposited on the intermediate transfer body 212. This solvent removal roller 250 is constituted by a porous member, for example, and absorbs and removes liquid from the intermediate transfer body 212.

The solvent removal roller 250 according to the present embodiment also serves as a suction device which removes liquid droplets that have been deposited on the intermediate transfer body 212 by dummy ejection. Rather than suctioning up solvent by capillary action using a porous member, it is also possible to employ a suctioning mechanism which suctions and removes the solvent by suction using a pump, or the like.

In the example illustrated in the drawing, one solvent removal roller 250 is provided on the furthest downstream side of the group of ink heads, but there is also a mode in which a solvent removal roller 250 is provided respectively on the downstream side of each of heads of the respective colors (112K, 112C, 112M and 112Y). This mode is especially suitable for cases where the amount of solvent of the ink deposited by the heads is high, since it enables the excess solvent to be recovered reliably.

The transfer unit 214 which transfers an image from the intermediate transfer body 212 to the recording paper 116 is disposed on the downstream side of the solvent removing roller 250 in terms of the direction of rotation of the transfer body. A nip roller 228 is provided in the transfer unit 214 at a position which opposes the third roller 220 via the intermediate transfer body 212, and a prescribed nip pressure is applied by the nip roller 228 to the rear surface side of the recording paper 116 (the opposite side to the recording surface).

In this way, an image (secondary image) is transferred to the recording paper 116 when the paper passes through the transfer unit 214, and the printed object thus generated (namely, recording paper 116 on which an image has been formed) is output from the print output unit (not illustrated).

As illustrated by the example in FIG. 29, it is also possible to apply the present invention to an inkjet recording apparatus of an intermediate transfer type.

### Modification Example 1

In the embodiment illustrated in FIG. 29, a composition is described in which droplets of treatment liquid are ejected first and then droplets of ink are ejected subsequently, but the droplet ejection sequence of the treatment liquid and the ink is not limited to this example and it is also possible to adopt a mode in which droplets of ink ejected first and droplets of treatment liquid are ejected subsequently, or a mode in which treatment liquid and ink are deposited on the medium simultaneously, or the like.

### Modification Example 2

In FIG. 29, only one treatment liquid ejection head 211 is disposed on the furthest upstream side of the group of ink heads, but it is also possible to adopt a composition in which treatment liquid ejection heads are disposed respectively on the upstream side (or the downstream side) of each of the heads 112K, 112M, 112C and 112Y of the respective colors. By means of this composition, it is possible to deposit a suitable amount of treatment liquid respectively and independently for each color of ink.

### Modification Example 3

In FIG. 29, treatment liquid is deposited by an inkjet type of ejection head (211), but it is also possible to adopt a mode in which treatment liquid is deposited by an application device (not illustrated), which is typically an application roller, such as a gravure roller, instead of the ejection head.

### Modification Example 4

It is also possible to adopt a mode in which a heating device and/or drying device (not illustrated) is provided instead of or in combination with the solvent removal roller 250 in FIG. 29.

For the heating device and the drying device, it is possible to employ an apparatus (device) which generates an infrared beam, microwaves or heated air, or a mode which brings a heated body into contact with the medium, or the like.

The heating device and drying device also serve as devices for drying the liquid droplets which are deposited onto the intermediate transfer body 212 by dummy ejection.

### Third Example of Composition of Inkjet Recording Apparatus

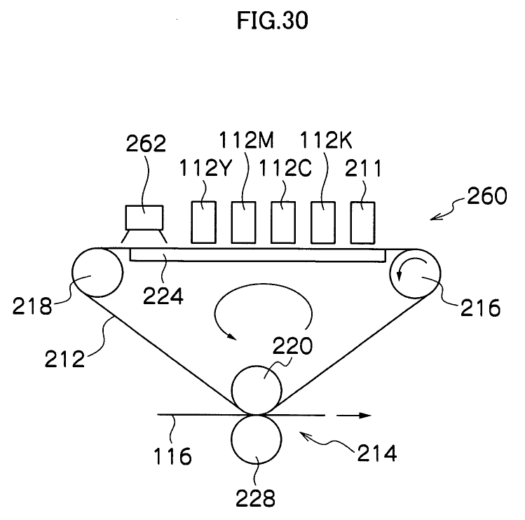

FIG. 30 is a principal schematic drawing illustrating a further example of the composition of the inkjet recording apparatus. In FIG. 30, elements which are the same as or similar to those in FIG. 29 are labeled with the same reference numerals and further explanation thereof is omitted here. The inkjet recording apparatus 260 illustrated in FIG. 30 is an inkjet recording apparatus of an intermediate transfer type which uses an ultraviolet-curable ink (so-called “UV ink”).

This inkjet recording apparatus 260 uses an ultraviolet light source 262 which is disposed after the head group. This ultraviolet light source 262 functions as a device for curing the ink by irradiating ultraviolet light onto the ink which has been deposited on the intermediate transfer body 212.

A primary image is formed onto the intermediate transfer body 212 by means of the ink ejected from the respective heads 112K, 112M, 112C and 112Y becoming attached to the intermediate transfer body 212. With the movement of the intermediate transfer body 212, this primary image receives the irradiation of ultraviolet light from the ultraviolet light source 262.

The ink on the intermediate transfer body 212 is polymerized and cured by ultraviolet light and is provisionally fixed onto the intermediate transfer body 212 in a cured ink state. The amount of ultraviolet light irradiated (the energy density and the irradiation time) are controlled so as to apply the energy required in order to cure the ink.

The ultraviolet source 262 has a structure in which, for example, a plurality of ultraviolet LED elements are arranged in a line configuration following the breadthways direction of the intermediate transfer body 212, cylindrical condensing lenses or a micro lens array being disposed below this row of ultraviolet LED elements. It is also possible to employ a composition using LD (laser diode) elements instead of LEDs.

The light emitted from the group of ultraviolet LED elements is condensed into a line shape following a direction that is substantially perpendicular to the paper feed direction by the action of the cylindrical lenses, and is irradiated onto the intermediate transfer body 212. Instead of the cylindrical lenses, it is also possible to use a group of lenses having one or more aspherical surface having an optically refractive shape and a condensing power which is similar to that of the cylindrical lenses.

By selectively emitting light from the group of ultraviolet LED elements and controlling the amount of light emitted from the respective elements, it is possible to achieve a desired irradiation range and light amount (intensity) distribution in the irradiation area of the ultraviolet light.

By suitably controlling the light emission positions and the light emission amounts of the ultraviolet LED elements in accordance with the range of ink droplet ejection and the ink volume so as to emit the minimum necessary amount of light, then adverse effects to the head (the curing of ink inside the nozzles, and the like) are restricted to a minimum.

The ultraviolet light source 262 according to the present embodiment also serves as an energy beam irradiation device which cures liquid droplets that have been deposited on the intermediate transfer body 212 by dummy ejection.

### Modification Example 5

The energy beam also includes visible light, ultraviolet light, electromagnetic waves including X rays, an electron beam, and the like, and apart from the ultraviolet-curable ink described above, another typical example of the energy beam-curable ink is an electron beam-curable ink (a so-called “EB ink”).

When an EB ink is used, an electron beam irradiation apparatus (not illustrated) is disposed instead of the ultraviolet light source 262. In other words, the concrete composition of the energy beam irradiation device is selected in accordance with the type of ink used.

### Modification Example 6

It is also possible to adopt a mode which uses a drum-shaped intermediate transfer body (intermediate transfer drum) instead of the intermediate transfer body 212 comprising an endless belt illustrated in FIG. 29 and FIG. 30.

### Modification Example 7

In the respective embodiments described above, an inkjet recording apparatus using a page-wide full line type head having a nozzle row of a length corresponding to the entire width of the recording medium is described, but the scope of application of the present invention is not limited to this, and the present invention may also be applied to an inkjet recording apparatus which performs image recording by means of a plurality of head scanning actions which move a short recording head, such as a serial head (shuttle scanning head), or the like.

Furthermore, the meaning of the term “image forming apparatus” is not restricted to a so-called graphic printing application for printing photographic prints or posters, but rather also encompasses industrial apparatuses which are able to form patterns that may be perceived as images, such as resist printing apparatuses, wire printing apparatuses for electronic circuit substrates, ultra-fine structure forming apparatuses, or the like.

One compositional example of a liquid ejection head according to an embodiment of the present invention is a full line type head in which a plurality of nozzles are arranged through a length corresponding to the full width of the ejection receiving medium. In this case, a mode may be adopted in which a plurality of relatively short recording head modules having nozzle rows which do not reach a length corresponding to the full width of the ejection receiving medium are combined and joined together, thereby forming nozzle rows of a length that correspond to the full width of the ejection receiving medium.

A full line type head is usually disposed in a direction that is perpendicular to the feed direction (conveyance direction) of the ejection receiving medium, but a mode may also be adopted in which the head is disposed following an oblique direction that forms a prescribed angle with respect to the direction perpendicular to the conveyance direction.

The conveyance device for causing the ejection receiving medium and the liquid ejection head to move relative to each other may include a mode where the ejection receiving medium is conveyed with respect to a stationary (fixed) head, or a mode where a head is moved with respect to a stationary ejection receiving medium, or a mode where both the head and the ejection receiving medium are moved.

The “ejection receiving medium” is a medium which receives the deposition of liquid droplets ejected from a nozzle(s) (an ejection port(s)) of a liquid ejection head, and this term includes a print medium, image forming medium, recording medium, image receiving medium, ejection receiving medium, intermediate transfer body, and a conveyance device such as a conveyance belt of a recording medium, and the like, in an inkjet printer. There are no particular restrictions on the shape or material of the medium, which may be various types of media, irrespective of material and size, such as continuous paper, cut paper, sealed paper, resin sheets such as OHP sheets, film, cloth, a printed circuit substrate on which a wiring pattern, or the like, is formed, a rubber sheet, a metal sheet, or the like.

When forming color images by using an inkjet head, it is possible to provide a recording head for each color of a plurality of colored inks (recording liquids), or it is possible to eject inks of a plurality of colors, from one print head.

It should be understood that there is no intention to limit the invention to the specific forms disclosed, but on the contrary, the invention is to cover all modifications, alternate constructions and equivalents falling within the spirit and scope of the invention as expressed in the appended claims.

1. A nozzle plate comprising:
a plurality of nozzles which eject a liquid; and
a plurality of projecting sections formed in a broken line shape or an island shape about periphery of the plurality of nozzles on a liquid ejection surface of the nozzle plate.

2. The nozzle plate as defined in claim 1, wherein the plurality of projecting sections are formed in an inclined shape with respect to a wiping direction of the nozzle plate.

3. The nozzle plate as defined in claim 1, wherein the plurality of projecting sections are formed in a parallel shape with respect to a wiping direction of the nozzle plate.

4. The nozzle plate as defined in claim 1, wherein the plurality of projecting sections are formed in a lattice configuration constituted by first lines which are inclined with respect to the wiping direction and second lines which are parallel to the wiping direction, with the projecting sections at intersecting portions between the first lines and the second lines being removed from the lattice configuration.

5. A nozzle plate comprising:
a plurality of nozzles which eject a liquid; and
a plurality of projecting sections which have an inclined shape with respect to a wiping direction of the nozzle plate and are formed about periphery of the plurality of nozzles on a liquid ejection surface of the nozzle plate.

6. The nozzle plate as defined in claim 2, wherein the plurality of projecting sections are disposed between the nozzles in the wiping direction.

7. The nozzle plate as defined in claim 3, wherein the plurality of projecting sections are disposed between the nozzles in the wiping direction.

8. The nozzle plate as defined in claim 4, wherein the plurality of projecting sections are disposed between the nozzles in the wiping direction.

9. The nozzle plate as defined in claim 5, wherein the plurality of projecting sections are disposed between the nozzles in the wiping direction.

10. The nozzle plate as defined in claim 1, wherein the plurality of projecting sections include: first projecting sections having an inclined shape toward one side with respect to the wiping direction; and second projecting sections having an inclined shape toward another side respect to the wiping direction.

11. The nozzle plate as defined in claim 10, wherein the first projecting sections and the second projecting sections are formed alternately between the nozzles in the wiping direction.

12. The nozzle plate as defined in claim 10, wherein:
the plurality of nozzles are arranged in form of a plurality of nozzle rows in the wiping direction;
of the nozzle rows arranged adjacently, the first projecting sections are arranged in one nozzle row and the second projecting sections are arranged in another nozzle row; and
the first projecting sections and the second projecting sections are disposed between the nozzles in the respective nozzle rows.

13. The nozzle plate as defined in claim 2, wherein:
the plurality of nozzles are arranged in the wiping direction to form a nozzle row; and
the plurality of projecting sections are disposed in a distributed fashion between the nozzles in the nozzle row, and in a portion outside of the nozzle row.

14. The nozzle plate as defined in claim 3, wherein:
the plurality of nozzles are arranged in the wiping direction to form a nozzle row; and
the plurality of projecting sections are disposed in a distributed fashion between the nozzles in the nozzle row, and in a portion outside of the nozzle row.

15. The nozzle plate as defined in claim 4, wherein:
the plurality of nozzles are arranged in the wiping direction to form a nozzle row; and
the plurality of projecting sections are disposed in a distributed fashion between the nozzles in the nozzle row, and in a portion outside of the nozzle row.

16. The nozzle plate as defined in claim 5, wherein:
the plurality of nozzles are arranged in the wiping direction to form a nozzle row; and
the plurality of projecting sections are disposed in a distributed fashion between the nozzles in the nozzle row, and in a portion outside of the nozzle row.

17. The nozzle plate as defined in claim 7, wherein:
the plurality of nozzles are arranged in the wiping direction to form a nozzle row; and
the plurality of projecting sections are disposed in a distributed fashion between the nozzles in the nozzle row, and in a portion outside of the nozzle row.

18. The nozzle plate as defined in claim 5, wherein the plurality of projecting sections are formed in a lattice configuration constituted by first lines which are inclined with respect to the wiping direction and the second lines which are parallel to the wiping direction.

19. The nozzle plate as defined in claim 5, wherein the plurality of projecting sections are formed in an undulating line shape which bends back and forth repeatedly while passing between the plurality of nozzles.

20. The nozzle plate as defined in claim 1, wherein the plurality of projecting sections are formed of a curable resin material.

21. The nozzle plate as defined in claim 5, wherein the plurality of projecting sections are formed of a curable resin material.

22. The nozzle plate as defined in claim 1, wherein the plurality of projecting sections have surfaces with a curved shape.

23. The nozzle plate as defined in claim 5, wherein the plurality of projecting sections have surfaces with a curved shape.

24. A liquid ejection head comprising a nozzle plate comprising:
a plurality of nozzles which eject a liquid; and
a plurality of projecting sections formed in a broken line shape or an island shape about periphery of the plurality of nozzles on a liquid ejection surface of the nozzle plate.

25. A liquid ejection head comprising a nozzle plate as comprising:
a plurality of nozzles which eject a liquid; and
a plurality of projecting sections which have an inclined shape with respect to a wiping direction of the nozzle plate and are formed about periphery of the plurality of nozzles on a liquid ejection surface of the nozzle plate.

26. An image forming apparatus comprising a liquid ejection head comprising the nozzle plate comprising:
a plurality of nozzles which eject a liquid; and
a plurality of projecting sections formed in a broken line shape or an island shape about periphery of the plurality of nozzles on a liquid ejection surface of the nozzle plate.

27. An image forming apparatus comprising a liquid ejection head comprising:
a plurality of nozzles which eject a liquid; and
a plurality of projecting sections which have an inclined shape with respect to a wiping direction of the nozzle plate and are formed about periphery of the plurality of nozzles on a liquid ejection surface of the nozzle plate.
